(19) United States
(12) Patent Application Publication
(10) Pub. No.: US 2024/0420668 A1
(43) Pub. Date: Dec. 19, 2024

(54) SYSTEMS, METHODS, AND COMPUTER PROGRAM PRODUCTS FOR GENERATING MOTIF STRUCTURES AND MUSIC CONFORMING TO MOTIF STRUCTURES

(71) Applicant: Obeebo Labs Ltd., Petaluma, CA (US)

(72) Inventor: Colin P. Williams, Half Moon Bay, CA (US)

(21) Appl. No.: 18/428,412

(22) Filed: Jan. 31, 2024

Related U.S. Application Data
(60) Provisional application No. 63/442,221, filed on Jan. 31, 2023.

(51) Int. Cl. G10H 1/00

(52) U.S. Cl. CPC G10H 1/0025; G10H 2210/056; G10H 2210/576

(57) ABSTRACT

Computer-based systems, methods, and computer program products for generating musical motif structures and musical compositions that conform to motif structures are described. This includes the generation of single-track music containing musical motifs that conform to a motif structure, as well as the generation of multi-track music containing: a) a set of single-tracks that harmonize and complement each other; and b) at least one track of music containing motifs that conform to a motif structure.

### TECHNICAL FIELD

The present systems, computer program products, and methods generally relate to computer-generated music, and particularly relate to systems, methods, and computer program products for generating musical motif structures and music conforming to such motif structures.

### BACKGROUND

### Description of the Related Art

### Composing Musical Compositions

A musical composition may be characterized by sequences of sequential, simultaneous, and/or overlapping notes that are partitioned into one or more tracks. Starting with an original musical composition, a new musical composition or “variation” can be composed by manipulating the “elements” (e.g., notes, bars, tracks, arrangement, etc.) of the original composition. As examples, different notes may be played at the original times, the original notes may be played at different times, and/or different notes may be played at different times. Further refinements can be made based on many other factors, such as changes in musical key and scale, different choices of chords, different choices of instruments, different orchestration, changes in tempo, the imposition of various audio effects, changes to the sound levels in the mix, and so on.

In order to compose a new musical composition (or variation) based on an original or previous musical composition, it is typically helpful to have a clear characterization of the elements of the original musical composition. In addition to notes, bars, tracks, and arrangements, “segments” are also important elements of a musical composition. In this context, the term “segment” (or “musical segment”) is used to refer to a particular sequence of bars (i.e., a subset of serially-adjacent bars) that represents or corresponds to a particular section or portion of a musical composition. A musical segment may include, for example, an intro, a verse, a pre-chorus, a chorus, a bridge, a middle8, a solo, or an outro. The section or portion of a musical composition that corresponds to a “segment” may be defined, for example, by strict rules of musical theory and/or based on the sound or theme of the musical composition.

### Musical Notation

Musical notation broadly refers to any application of inscribed symbols to visually represent the composition of a piece of music. The symbols provide a way of “writing down” a song so that, for example, it can be expressed and stored by a composer and later read and performed by a musician. While many different systems of musical notation have been developed throughout history, the most common form used today is sheet music.

Sheet music employs a particular set of symbols to represent a musical composition in terms of the concepts of modern musical theory. Concepts like: pitch, rhythm, tempo, chord, key, dynamics, meter, articulation, ornamentation, and many more, are all expressible in sheet music. Such concepts are so widely used in the art today that sheet music has become an almost universal language in which musicians communicate.

### Digital Audio File Formats

While it is common for human musicians to communicate musical compositions in the form of sheet music, it is notably uncommon for computers to do so. Computers typically store and communicate music in well-established digital audio file formats, such as .mid, .wav, or .mp3 (just to name a few), that are designed to facilitate communication between electronic instruments and other computer program products by allowing for the efficient movement of musical waveforms over computer networks. In a digital audio file format, audio data is typically encoded in one of various audio coding formats (which may be compressed or uncompressed) and either provided as a raw bitstream or, more commonly, embedded in a container or wrapper format.

### BRIEF SUMMARY

A computer-implemented method of generating motif structures is described herein.

A system for generating motif structures is described herein.

A computer program product for generating motif structures is described herein.

A computer-implemented method of generating individual motif elements is described herein.

A system for generating individual motif elements is described herein.

A computer program product for generating individual motif elements is described herein.

A computer-implemented method of generating single-track music in targeted ambient mood(s), and/or desired key/scale(s), and/or genres, using a motif structure is described herein.

A system for generating single-track music in targeted ambient mood(s), and/or desired key/scale(s), and/or genres, using a motif structure is described herein.

A computer program product for generating single-track music in targeted ambient mood(s), and/or desired key/scale(s), and/or genres, using a motif structure is described herein.

A computer-implemented method of generating multi-track music in targeted ambient mood(s), and/or desired key/scales, and/or genres, using a motif structure is described herein.

A system for generating multi-track music in targeted ambient mood(s), and/or desired key/scales, and/or genres, using a motif structure is described herein.

A computer program product for generating multi-track music in targeted ambient mood(s), and/or desired key/scales, and/or genres, using a motif structure is described herein.

A computer-implemented method of generating a motif structure may be summarized as including: accessing, by at least one processor, a musical composition encoded in a digital file format, the digital file format stored in a non-transitory processor-readable storage medium communicatively coupled to the at least one processor; for at least one track of the musical composition, extracting a respective motif from each of multiple bars in the at least one track; for multiple respective sets of extracted motifs, determining a respective similarity between motifs in the set of extracted motifs; clustering the extracted motifs into clusters based at least in part on the determined similarity between respective sets of extracted motifs; and generating a motif structure matrix with columns indexed by bar indices and rows indexed by track indices. For at least one track of the musical composition, extracting a respective motif from each of multiple bars in the at least one track may include, for each track of the musical composition, extracting a respective motif from each bar in the track. For multiple respective sets of extracted motifs, determining a respective similarity between the set of extracted motifs may include, for each extracted motif in each bar of each track, determining a respective similarity between the extracted motif and each extracted motif in each other bar in each other track.

The method may further include, before extracting a respective motif from each of multiple bars in the at least one track: converting the digital file format into an alternative file format in which each track of the musical composition is designated by a respective object; and splitting the musical composition into a set of track objects.

Each motif may be characterized as a respective sequence of triples, with each respective triple consisting of a respective note, a respective duration, and a respective volume.

Determining a respective similarity between motifs in the set of extracted motifs may include any or all of: identifying at least one set of motifs that are syntactically the same and identifying at least one set of motifs that are syntactically different; determining a respective similarity between motifs in the set of extracted motifs based at least in part on a quantity that is inversely proportional to a distance in distribution between distributions of features for each motif; determining a respective similarity measure between motifs in the set of extracted motifs, the similarity measure higher when motifs in the set of extracted motifs have a greater percentage of notes in common, and the similarity measure higher when motifs in the set of extracted motifs have a greater percentage of common notes in the same order; and/or determining a respective similarity between motifs in the set of extracted motifs based at least in part on a dynamic time warping distance between motifs in the set of extracted motifs.

A computer-implemented method of generating a musical composition may be summarized as including: accessing, by at least one processor, a motif structure, the motif structure stored in a non-transitory processor-readable storage medium communicatively coupled to the at least one processor; determining a number k of distinct motifs in the motif structure; generating a chord progression comprising k chords; assigning a respective one of the k chords to each respective one of the k distinct motifs in the motif structure; generating a respective motif corresponding to each respective one of the k distinct motifs in the motif structure, each respective generated motif based at least in part on a corresponding one of the k chords; assembling the generated motifs into a sequence of musical bars; and concatenating the bars.

Generating a respective motif corresponding to each respective one of the k distinct motifs in the motif structure, each respective generated motif based at least in part on a corresponding one of the k chords, may include, for each generated motif, constructing a sequence of notes comprising notes available in the one of the k chords that corresponds to the generated motif. The method may further include accumulating bar durations to shift a start time of the generated motif for each bar.

The method may further include specifying at least one mood for the musical composition, wherein generating a chord progression comprising k chords includes generating a chord progression comprising k chords, the k chords including at least one chord corresponding to the specified mood.

A computer program product may be summarized as including a non-transitory processor-readable storage medium storing data and/or processor-executable instructions that, when executed by at least one processor of a computer-based musical composition system, cause the computer-based musical composition system to: access a musical composition encoded in a digital file format, the digital file format stored in a non-transitory processor-readable storage medium communicatively coupled to the at least one processor; for at least one track of the musical composition, extract a respective motif from each of multiple bars in the at least one track; for multiple respective sets of extracted motifs, determine a respective similarity between motifs in the set of extracted motifs; cluster the extracted motifs into clusters based at least in part on the determined similarity between respective sets of extracted motifs; and generate a motif structure matrix with columns indexed by bar indices and rows indexed by track indices. The processor-executable instructions that, when executed by at least one processor, cause the computer-based musical composition system to, for at least one track of the musical composition, extract a respective motif from each of multiple bars in the at least one track, may cause the computer-based musical composition system to, for each track of the musical composition, extract a respective motif from each bar in the track. The computer program product may further include processor-executable instructions that, when executed by at least one processor, cause the computer-based musical composition system to, before extracting a respective motif from each of multiple bars in the at least one track: convert the digital file format into an alternative file format in which each track of the musical composition is designated by a respective object; and split the musical composition into a set of track objects.

Each motif may be characterized as a respective sequence of triples, with each respective triple consisting of a respective note, a respective duration, and a respective volume.

The processor-executable instructions that, when executed by at least one processor, cause the computer-based musical composition system to determine a respective similarity between motifs in the set of extracted motifs, may cause the computer-based musical composition system to do any or all of: identify at least one set of motifs that are syntactically the same and identify at least one set of motifs that are syntactically different; determine a respective similarity between motifs in the set of extracted motifs based at least in part on a quantity that is inversely proportional to a distance in distribution between distributions of features for each motif; and/or determine a respective similarity between motifs in the set of extracted motifs based at least in part on a dynamic time warping distance between motifs in the set of extracted motifs.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

The various elements and acts depicted in the drawings are provided for illustrative purposes to support the detailed description. Unless the specific context requires otherwise, the sizes, shapes, and relative positions of the illustrated elements and acts are not necessarily shown to scale and are not necessarily intended to convey any information or limitation. In general, identical reference numbers are used to identify similar elements or acts.

FIG. 1 shows an exemplary graphical representation of a motif structure, wherein the horizontal axis denotes increasing bar index from left to right, and the vertical axis denotes a specific track index in accordance with the present systems, computer program products, and methods.

FIG. 2A shows a portion of an exemplary postulated motif structure, without percussion (i.e., tonal only), in accordance with the present systems, methods, and computer program products.

FIG. 2B shows a portion of an exemplary postulated motif structure with percussion in accordance with the present systems, methods, and computer program products.

FIG. 3 shows an exemplary hypothetical high-level song structure, in terms of a sequence of musical elements, wherein each musical element represents a sequence of motifs spanning one or more bars in accordance with the present systems, methods, and computer program products.

FIG. 4 presents an exemplary table showing each high-level musical element from FIG. 3 expanded into a corresponding sequence of motifs, each spanning one or more bars in accordance with the present systems, methods, and computer program products.

FIG. 5 provides two tables showing examples of how to find which note durations correspond to which note types: one for a 4/4 meter at 100 BPM, and one for a 5/4 meter at 73 BPM.

FIG. 6. shows an illustrative comparison between Euclidean Matching and Dynamic Time Warping Matching in accordance with the present systems, methods, and computer program products.

FIG. 7 shows illustrative examples of 6 different noise models used for the purpose of creating a musical motif in accordance with the present systems, methods, and computer program products.

FIG. 8 shows a graph of f(i)=1−logistic (0.15(i−48)) where i is the absolute value of the note interval, and logistic(x)=1/(1+exp(−x)) for any argument x, in accordance with the present systems, methods, and computer program products.

FIG. 9 is an illustrative diagram of a processor-based computer system suitable at a high level for performing the various computer-implemented methods described in the present systems, computer program products, and methods.

FIG. 10 is a flow diagram of a computer-implemented method of generating a motif structure in accordance with the present systems, computer program products, and methods.

FIG. 11 is a flow diagram of a computer-implemented method of generating a musical composition (e.g., based on a given motif structure) in accordance with the present systems, computer program products, and methods.

### DETAILED DESCRIPTION

The following description sets forth specific details in order to illustrate and provide an understanding of the various implementations and embodiments of the present systems, computer program products, and methods. A person of skill in the art will appreciate that some of the specific details described herein may be omitted or modified in alternative implementations and embodiments, and that the various implementations and embodiments described herein may be combined with each other and/or with other methods, components, materials, etc. in order to produce further implementations and embodiments.

In some instances, well-known structures and/or processes associated with computer systems and data processing have not been shown or provided in detail in order to avoid unnecessarily complicating or obscuring the descriptions of the implementations and embodiments.

Unless the specific context requires otherwise, throughout this specification and the appended claims the term “comprise” and variations thereof, such as “comprises” and “comprising,” are used in an open, inclusive sense to mean “including, but not limited to.”

Unless the specific context requires otherwise, throughout this specification and the appended claims the singular forms “a,” “an,” and “the” include plural referents. For example, reference to “an embodiment” and “the embodiment” include “embodiments” and “the embodiments,” respectively, and reference to “an implementation” and “the implementation” include “implementations” and “the implementations,” respectively. Similarly, the term “or” is generally employed in its broadest sense to mean “and/or” unless the specific context clearly dictates otherwise.

The headings and Abstract of the Disclosure are provided for convenience only and are not intended, and should not be construed, to interpret the scope or meaning of the present systems, computer program products, and methods.

The various embodiments described herein provide systems, computer program products, and methods for computer-based generation of musical motifs and musical composition that employ or conform to such motifs. Specifically, the present systems, methods, and computer program products describe the generation of motif structures, the generation of single-track music containing musical motifs that conform to a motif structure, and the generation of multi-track music containing a set of single-tracks that harmonize and complement each other and at least one track of music containing motifs that conform to a motif structure.

Throughout this specification and the appended claims, a musical variation is considered a form of musical composition and the term “musical composition” (as in, for example, “computer-generated musical composition” and “computer-based musical composition system”) is used to include musical variations.

Systems, computer program products, and methods for encoding musical compositions in hierarchical data structures of the form Music[Segments{ }, barsPerSegment{ }] are described in U.S. Pat. No. 10,629,176, filed Jun. 21, 2019 and entitled “Systems, Devices, and Methods for Digital Representations of Music” (hereinafter “Hum Patent”), which is incorporated by reference herein in its entirety.

Systems, computer program products, and methods for automatically identifying the musical segments of a musical composition and which can facilitate encoding musical compositions (or even simply undifferentiated sequences of musical bars) into the Music[Segments{ }, barsPerSegment{ }] form described above are described in U.S. Pat. No. 11,024,274, filed Jan. 28, 2020 and entitled “Systems, Devices, and Methods for Segmenting a Musical Composition into Musical Segments” (hereinafter “Segmentation Patent”), which is incorporated herein by reference in its entirety.

Systems, computer program products, and methods for identifying harmonic structure in digital data structures and for mapping the Music[Segments{ }, barsPerSegment{ }] data structure into an isomorphic HarmonicStructure[Segments{ }, harmonicSequencePerSegment{ }] data structure are described in U.S. Pat. No. 11,361,741, filed Jan. 28, 2020 and entitled “Systems, Devices, and Methods for Harmonic Structure in Digital Representations of Music” (hereinafter “Harmony Patent”), which is incorporated herein by reference in its entirety.

Systems, computer program products, and methods for generating aesthetic chord progressions and key modulations in musical compositions are described in US Patent Publication US 2021-0407477 A1 (hereafter “Chord Progression Patent”), which is incorporated herein by reference in its entirety.

Systems, computer program products, and methods for computer-generated musical note sequences are described in US Patent Publication US 2021-0241734 A1 (hereafter “Note Sequences Patent”), which is incorporated herein by reference in its entirety.

Systems, computer program products, and methods for assigning mood labels to musical compositions are described in US Patent Publication US 2021-0241731 A1 (hereafter “Mood Label Patent”), which is incorporated herein by reference in its entirety.

Systems, methods, and computer program products for generating deliberate sequences of moods in musical compositions are described in U.S. Provisional Patent Application 63/340,524, filed May 11, 2022 (hereafter “Mood Sequence Patent”), which is incorporated herein by reference in its entirety.

In Mood Label Patent and Mood Sequence Patent, some implementations include achieving a desired musical mood by associating certain mood labels with certain key/scale combinations, certain chord types, and/or certain chord type transitions. In the present systems, methods, and computer program products, these concepts are extended and further developed to generate single-track and multi-track music that contains musical “motifs” within a desired “motif structure”, while preserving desired mood(s) and/or genre(s).

Throughout this specification and the appended claims, the term “motif” is used to describe or refer to a note sequence (e.g., a short and salient note sequence) that deliberately repeats within a musical composition. A motif may be characterized as a short (e.g., the shortest) structural unit possessing “thematic identity” in a musical composition. For example, a motif is typically the “memorable” or “catchy” part of a modern film music score. Whereas an ambient musical mood may be established by means of a judicious choice of key/scale combinations, chord types, and/or chord type transitions, musical motifs are typically established by means of melodic lines, i.e., sequences of notes, or sequences of note intervals, in conjunction with patterns in timing and loudness. Hence, motifs are in some ways the building blocks of melodies. Functionally, motifs are often used in film music in a character-specific, location-specific, or situation-specific manner within the context of a more general ambient mood. As such, motifs typically convey information subliminally to an audience, in addition to adding aesthetically to the music.

A musical composition may contain a multiplicity of musical motifs, and throughout a musical composition relationships between these motifs may be developed across time and tracks. Exemplary relationships include motif repetition, motif transposition, motifs with different notes but the same timing pattern, as well as the entry and exit of various tracks of music that provide harmonization, and complementation to the essential motifs. Throughout this specification and appended claims, the term “motif structure” is used to refer to these relationships and, generally, the corresponding correlation structure in patterns of notes, patterns of durations, and patterns of volumes across bars (i.e., time) and across tracks. However, a motif structure may not be tied to correlations in specific note sequences, specific note timings, and specific note volumes across time and tracks, but instead may maintain a record of “correlation” or “similarity” between bar_p in track_q, and bar_r in track_s, without regard for what notes are played in what timing pattern and in what volumes. Hence, “motif structure” is similar to a correlation matrix, without restricting the detailed entities that are correlated to those in which the motif structure was originally designed, or from which the motif structure was originally learned. Clearly, different kinds of motif structures can be envisaged based on different choices of similarity measure between one motif and another.

Given a basic melody track that develops the essential motifs of a piece of music, it can be desirable to enrich that melody track with additional tracks that harmonize and complement it. In this context, throughout this specification and the appended claims, “harmonization” relates to a selection of notes that sound aesthetic when played in conjunction with other notes, such as those in a melody track, and “complementation” relates to a selection of note movements that are correlated (or partially correlated, or anti-correlated, or partially anti-correlated) with the note movements of other tracks. For example, one musical line might be generally ascending, while another musical line played simultaneously is generally descending etc. Harmonization and complementation may be considered and incorporated, either individually or both together, in the construction of correlated musical tracks that sound aesthetic. In accordance with the present systems, methods, and computer program products, such correlations in harmonization and, optionally note movements, can be captured in motif structure too by way of appropriate choice of “similarity measure” between two motifs.

Mood Sequence Patent describes, among other things, a method for creating a musical composition conveying a sequence of intended moods/feelings/emotions across a sequence of time intervals such as, but not limited to, time intervals delimiting the temporal boundaries of scenes within a movie, and/or the time intervals delimiting the temporal boundaries of elements of a song, such as but not limited to, the “Intro”, the “Verse”, the “Pre-Chorus”, the “Chorus”, the “Bridge”, and the “Outro”, etc. In some implementations described therein, a desired mood/feeling/emotion is achieved by way of explicit associations between certain mood labels and corresponding key/scale combinations, chord types, and/or chord type transitions. In the present systems, methods, and computer program products, these associations may be employed to determine the harmonic foundation for the motif of bar_p in track_q so as to achieve a motif conveying a desired mood. Thus, in some implementations the various systems, methods, and computer program products described herein extend techniques that generate mood-specific chord progressions to generate mood-specific motifs overlaying mood-specific chord progressions, which may conform to some overarching motif structure.

Throughout this specification and the appended claims, the term “genre” refers to a categorization system that defines pieces of music under a style according to their distinctive elements. All songs in the same genre share certain similarities in their forms, styles, instrumentation, and/or rhythm patterns. In the present systems, methods, and computer program products, musical motifs may be generated in a specific genre, and/or in a specific combination of mood and genre. Some exemplary elements that may be specified to tailor a motif structure to a specific genre include the meter (a.k.a. time signature), the tempo (a.k.a. bpm or “beats per minute”), the instrumentation (i.e., a restriction on the tonal and percussion instruments to be used), the places in a motif where stress is applied (e.g., “accents” or more loudness) or where softness (less loudness) is applied, and/or the rhythm pattern.

### Generating Motif Structures

In accordance with the present systems, methods, and computer program products, a motif may be regarded as a sequence of triples:
{{note1, duration1, volume1}, {note2, duration2, volume2}, . . . , {noteN, durationN, volumeN}} Throughout this specification and the appended claims, unless the specific context requires otherwise the term “note” includes any and/or all of: a single note (or an equivalent integer, including a rest or “silence”); a single note interval; a plurality of notes (or an equivalent plurality of note integers), such as but not limited to a chord; and/or a plurality of note intervals (including but not limited to a chord), played with either no timing offset, a constant timing offset, or a differential timing offset between the notes (or note intervals). Moreover, in each case, such a “note” may be octaved (i.e., have an octave specified explicitly), or octaveless (i.e., be a letter note without any designation of octave); or, as alluded to above, it could mean one or more equivalent note integer(s) as defined, e.g., by the associations: {“C-1”->−60, “C#-1”->−59, “Db-1”->−59, “D-1”->−58, “D #-1”->−57, “Eb-1”->−57, “E-1”->−56, “F-1”->−55, “F #-1”->−54, “Gb-1”->−54, “G-1”->−53, “Ab-1”->−52, “G #1”->−52, “A-1”->−51, “A #-1”->−50, “Bb-1”->−50, “B-1”->−49, “C0”->−48, “C#0”->−47, “Db0”->−47, “DO”->−46, “D #0”->−45, “Eb0”->−45, “E0”->−44, “F0”->−43, “F #0”->−42, “Gb0”->−42, “G0”->−41, “Ab0”->−40, “G #0”->−40, “A0”->−39, “A #0”->−38, “Bb0”->−38, “B0”->−37, “C1”->−36, “C#1”->−35, “Db1”->−35, “D1”->−34, “D #1”->−33, “Eb1”->−33, “E1”->−32, “F1”->−31, “F #1”->−30, “Gb1”->−30, “G1”->−29, “Ab1”->−28, “G #1”->−28, “A1”->−27, “A #1”->−26, “Bb1”->−26, “B1”->−25, “C2”->−24, “C#2”->−23, “Db2”->−23, “D2”->−22, “D #2”->−21, “Eb2”->−21, “E2”->−20, “F2”->−19, “F #2”->−18, “Gb2”->−18, “G2”->−17, “Ab2”->−16, “G #2”->−16, “A2”->−15, “A #2”->−14, “Bb2”->−14, “B2”->−13, “C3”->−12, “C#3”->−11, “Db3”->−11, “D3”->−10, “D #3”->−9, “Eb3”->−9, “E3”->−8, “F3”->−7, “F #3”->−6, “Gb3”->−6, “G3”->−5, “Ab3”->−4, “G #3”->−4, “A3”->−3, “A #3”->−2, “Bb3”->−2, “B3”->−1, “C”->0, “C4”->0, “C#”->1, “C#4”->1, “Db”->1, “Db4”->1, “D”->2, “D4”->2, “D #”->3, “D #4”->3, “Eb”->3, “Eb4”->3, “E”->4, “E4”->4, “F”->5, “F4”->5, “F #”->6, “F #4”->6, “Gb”->6, “Gb4”->6, “G”->7, “G4”->7, “Ab”->8, “Ab4”->8, “G #”->8, “G #4”->8, “A”->9, “A4”->9, “A #”->10, “A #4”->10, “Bb”->10, “Bb4”->10, “B”->11, “B4”->11, “C5”->12, “C#5”->13, “Db5”->13, “D5”->14, “D #5”->15, “Eb5”->15, “E5”->16, “F5”->17, “F #5”->18, “Gb5”->18, “G5”->19, “Ab5”->20, “G #5”->20, “A5”->21, “A #5”->22, “Bb5”->22, “B5”->23, “C6”->24, “C#6”->25, “Db6”->25, “D6”->26, “D #6”->27, “Eb6”->27, “E6”->28, “F6”->29, “F #6”->30, “Gb6”->30, “G6”->31, “Ab6”->32, “G #6”->32, “A6”->33, “A #6”->34, “Bb6”->34, “B6”->35, “C7”- >36, “C#7”->37, “Db7”->37, “D7”->38, “D #7”->39, “Eb7”->39, “E7”->40, “F7”->41, “F #7”->42, “Gb7”->42, “G7”->43, “Ab7”->44, “G #7”->44, “A7”->45, “A #7”->46, “Bb7”->46, “B7”->47, “C8”->48, “C#8”->49, “Db8”->49, “D8”->50, “D #8”->51, “Eb8”->51, “E8”->52, “F8”->53, “F #8”->54, “Gb8”->54, “G8”->55, “Ab8”->56, “G #8”->56, “A8”->57, “A #8”->58, “Bb8”->58, “B8”->59, “C9”->60, “C#9”->61, “Db9”->61, “D9”->62, “D #9”->63, “Eb9”-> 63, “E9”->64, “F9”->65, “F #9”->66, “Gb9”->66, “G9”->67}. Likewise, the term “duration” includes an actual period of time and/or a note type (such as “quarter note”, “eighth note”, “dotted eighth note”, etc.) which may be converted to an explicit period of time based on a defined meter and/or tempo.

To generate an aesthetic music track containing motifs, it can be advantageous to ensure the motifs are placed in a non-random manner. While neural network and deep learning approaches may use architectures such as a LSTM (long-short term memory), Convolutional Neural Networks, and so on, the various implementations described herein focus on an explicit representation of structure, called a “motif structure”, which serves as a guide during the (automated) music generation process. Specifically, a motif structure is a representation of the “correlation” or “similarity” between the motifs played in bar_p of track_q and bar_r of track_s.

In some implementations, a combination of neural network, deep learning, and/or other generative machine learning approaches to the motif generation may be employed while using the motif structure computed. For example, some combination of neural, symbolic, and/or statistical A1 approaches may be applied to the generation of music. More generally, the various implementations described herein include systems, methods, and computer program products that create music by combining a motif structure and a high level description of a musical goal such as that given in textual form, and/or a spoken form, and/or in a set of parameters, etc.

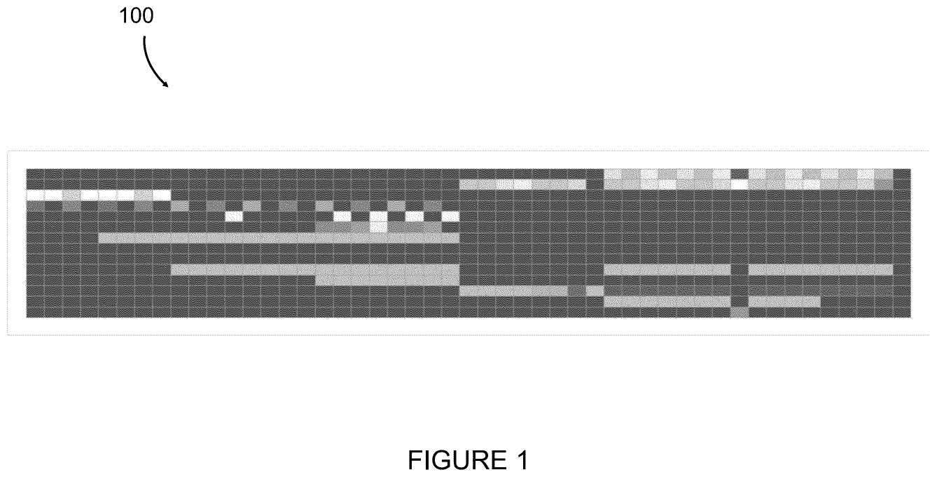

FIG. 1. shows a graphical representation of a motif structure 100, wherein the horizontal axis denotes increasing bar index from left to right, and the vertical axis denotes a specific track index. Cells of similar color represent similar motifs, the degree of similarity between motifs indicated by the degree of similarity between colors. Whereas a typical DAW (i.e., digital audio workstation) would provide a representation of a specific motif in each bar of each track, in the representation of FIG. 1 the explicit motif is entirely absent: only the correlation or similarity of motifs in different bar/track coordinates is captured. This elevates the representation of musical structure to something more abstract and re-usable. A darkest blue block represents silence, and blocks that are of similar colors represent similar motifs. FIG. 1 intentionally does not label the tracks with specific instruments, nor associate the various colored blocks with explicit motifs, i.e., explicit sequences of {note, duration, volume} triples to reinforce the idea that it is the correlation/similarity structure that matters more than the specific note, duration, and volume patterns.

In some implementations, each block of a motif structure may represent a specific set of {note, duration, volume} triples. In other implementations, each block of a motif structure may represent a specific set of {note, duration} pairs and a second motif structure may represent the corresponding volumes. In other implementations, each block of a motif structure may represent a specific set of {note, volume} pairs and a second motif structure may represent the corresponding durations. In other implementations, each block of a motif structure may represent a specific set of {duration, volume} pairs and a second motif structure may represent the corresponding notes. In other implementations, a first motif structure may represent a specific sequence of notes, a second motif may represent a specific sequence of durations, and a third motif structure may represent a specific sequence of volumes. In the foregoing, different similarity measures may be used for different representations of the elemental “motif”. For example, if elemental motifs are regarded as sequences of notes, a “similarity measure” may be based on a distance measure between sequences of notes (of potentially different lengths). Whereas, if elemental motifs are regarded sequences of {note, duration} pairs, a “similarity measure” may be based on a distance measure between sequences of {note, duration} pairs (of potentially different lengths).

a. Synthesizing a Motif Structure without Reference to Pre-Existing Music

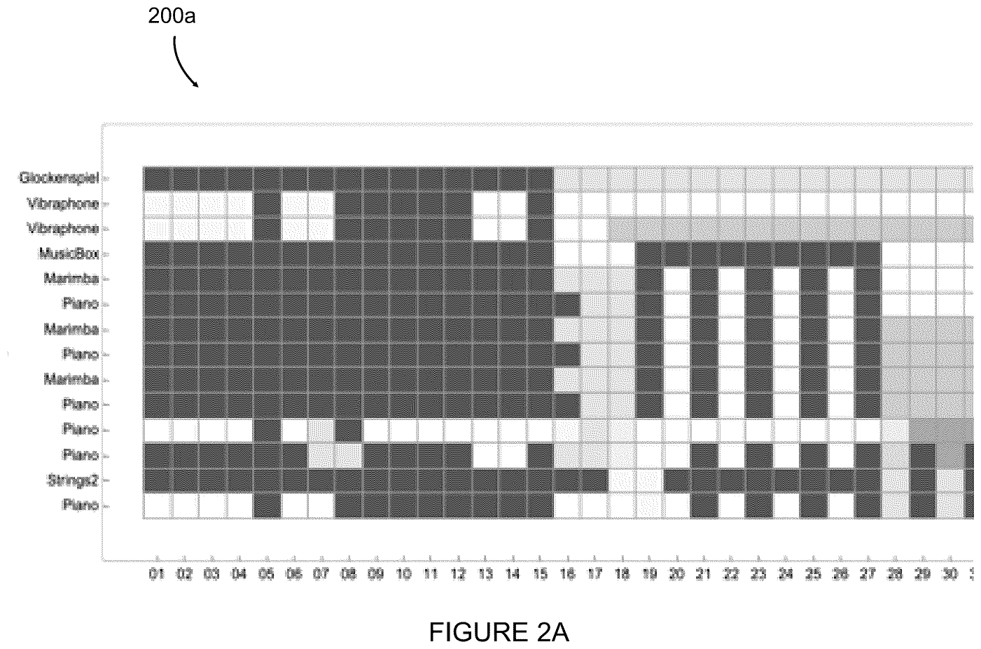

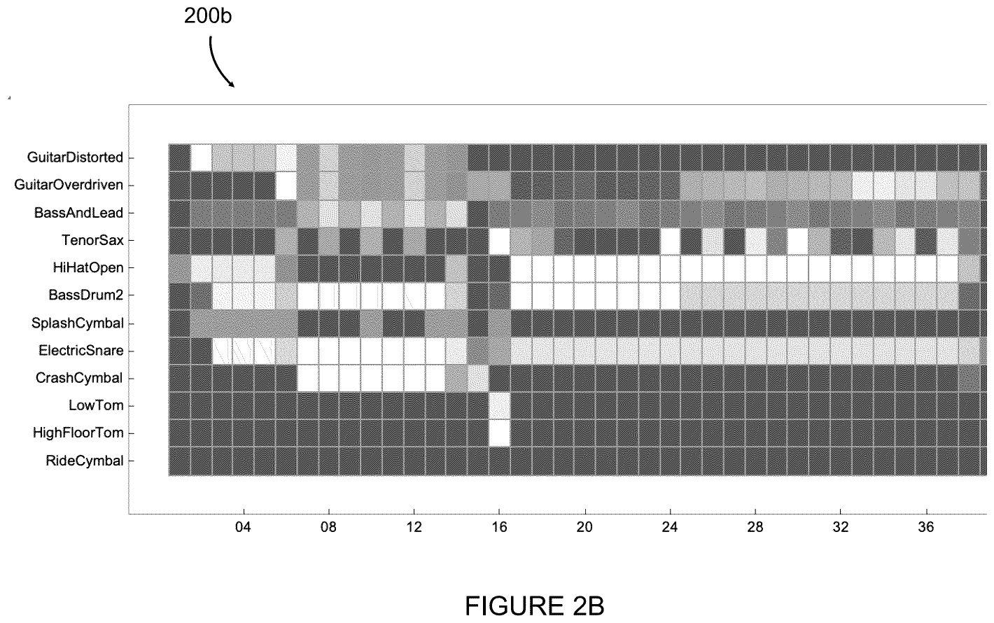

In some implementations, a motif structure may simply be posited. For example, one may begin by positing a high-level song structure such as that shown in FIG. 2A or FIG. 2B. FIG. 2A shows a portion of an exemplary postulated motif structure 200a without percussion (i.e., tonal only), and FIG. 2B shows a portion of an exemplary postulated motif structure 200b with percussion. In both cases a handful of hypothetical, and as yet unspecified, musical motifs are assembled into a motif structure. These motif structures may be used subsequently to guide composition.

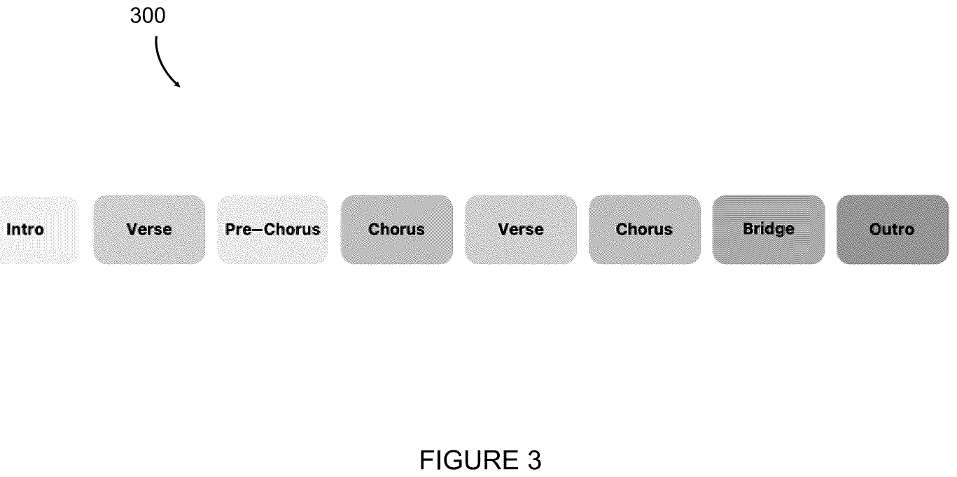

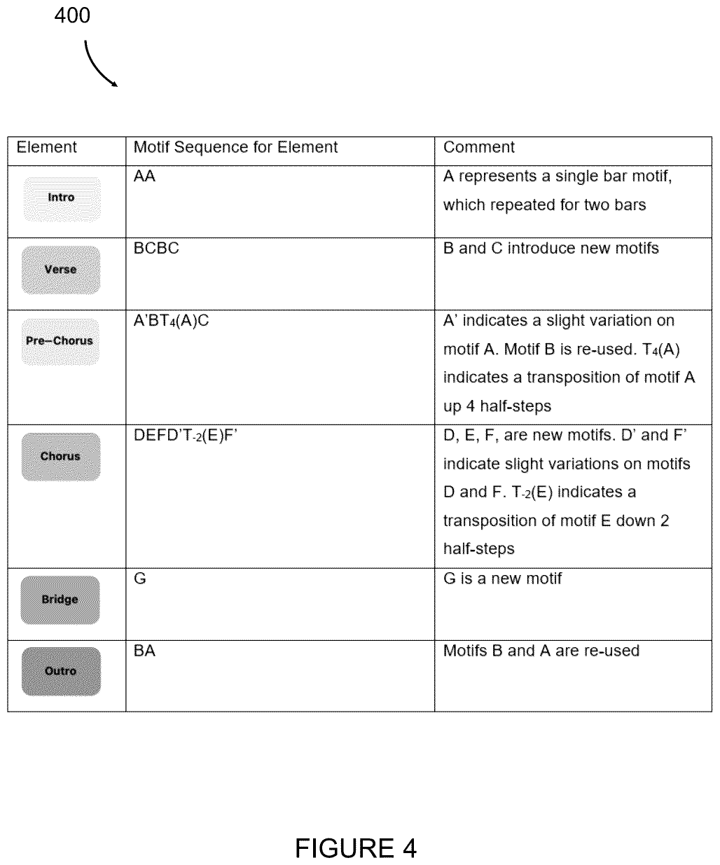

In some implementations, a hypothetical motif structure might be built hierarchically. First an overall song structure may be posited, such as that shown in FIG. 3. FIG. 3 shows a hypothetical high-level song structure 300, in terms of a sequence of musical elements, wherein each musical element represents a sequence of motifs spanning one or more bars. Each musical element may be expanded into hypothetical, and as yet unspecified, sequences of single-bar motifs, as shown in FIG. 4. FIG. 4 includes a table 400 showing each high-level musical element from FIG. 3 expanded into a corresponding sequence of motifs, each spanning one or more bars. Some motifs are repeated in the sequence, others are not, and some motifs are repeated with slight variations (in note sequence, and/or note timing, and/or note volume) as indicated with a prime superscript. In FIG. 4, a single letter represents a single motif spanning one, or more, bars. When the same letter is used in the expansion of different music elements, it represents the same motif. When the same letter is used with an added apostrophe in the expansion of different music elements, it represents a (usually slight) variation of the motif that originally used that letter.

In FIG. 4, a “variation” of a motif might include, e.g., a motif with exactly the same timing pattern, and predominantly the same note sequence with one or two notes changed. Or, a variation of a motif might include, e.g., a motif with predominantly the same timing pattern with one or two note types changed (e.g., a quarter note replaced by two eighth notes), and a subset of the original note sequence. However, more distant variations are possible too in accordance with the present systems, methods, and computer program products. It is possible that, given a motif structure created without reference to pre-existing music, such a structure can be used to create variations based on that structure. Generally, an initial motif structure can be created without reference to pre-existing music, and subsequently it may be used to create a multiplicity of variations.

b. Learning/Inferring a Motif Structure from Pre-Existing Music

In some implementations, rather than a motif structure being posited, it may be learned or inferred from a pre-existing piece of music. An example algorithm may proceed as follows:
1. Given:
   a. A file of music in a computer-readable format (such as MIDI)
   b. A choice as to what features constitute a “motif” . . .
      i.e., whether a motif is to be regarded as a sequence of {note, duration, volume} triples, or a motif is to be regarded as a sequence of notes, or a motif is to be regarded as a sequence of note types (e.g., {quarter, quarter, eighth, eighth, quarter}, etc.
   c. A choice of a “similarity measure” between motifs . . .
      appropriate for the representation of features chosen at step 1(b)
2. Output:
   a. A matrix, M, representing the similarity (as assessed by the similarity measure in 1(c)) of different motifs at different bar/track coordinates
3. Method:
   a. Map the MIDI to an alternative format, e.g., a HUM format per HUM Patent
   b. Split the HUM format into a HUM object for each track & record the track instrument
   c. For each bar of each track, extract the motif (w.r.t. those features chosen in 1(b))
   d. For each extracted motif in each bar of each track, compute the “similarity”, according to the “similarity measure” chosen in 1(c), between the motif in bar_p of track_q and the motif in bar_r of track_s
   e. Perform cluster analysis to find which motifs in which bar/track coordinates should be deemed “in the same cluster” and associate a symbol (or numeric value) with each distinct cluster
   f. Form a “motif structure matrix”, M, (with columns indexed by bar indices and rows indexed by track indices) in which element M_ij is the cluster symbol (or numeric value) assigned to the motif in bar_i of track_j.
   g. (Optionally) use this matrix to visualize the motif structure (creating a diagram such as that shown in FIG. 2)
   h. Return the matrix, M
      Some important aspects of the above exemplary algorithm include the selection of:
(a) Feature Set: which features to focus on as the primitive elements of a “motif”;
(b) Similarity Measure: what similarity measures to use to assess the distance between motifs (represented w.r.t. the chosen features), and
(c) Clustering Algorithm: what clustering methods to use to group the motifs into a (possibly) smaller number of motif clusters wherein motifs within the same cluster are taken to be equivalent. In some implementations where motif structures are used to generate music, music that respects the equivalence of motifs in the same cluster may be initially generated but then refined in a track-dependent and/or instrument-dependent way. For example, if the same motif appears in a motif structure to be played in one case by (say) a piccolo, and in another by (say) a tuba, the motif may be transposed to a note range that is appropriate for the instrument.
   Some Possible Feature Sets: With the understanding that the term “note” may include either a single note (or an equivalent integer) or a plurality of notes (or an equivalent plurality of note integers) and the term “interval” may include a single note interval, or a plurality of note intervals, with any of the foregoing having any of no timing offset, a constant timing offset, and/or a differential timing offset between the notes (or note integers or note intervals), the following are some exemplary features sets that could be used as the fingerprints of motifs at each bar/track coordinate:
1. a sequence of {note, duration, volume} triples, or
2. a sequence of {note, duration} pairs AND a sequence of volumes, or
3. a sequence of {note, volume} pairs AND a sequence of durations, or
4. a sequence of {duration, volume} pairs AND a sequence of notes, or
5. a sequence of notes, a sequence of durations, and a sequence of volumes
6. a sequence of {note, type, volume} triples, or
7. a sequence of {note, type} pairs AND a sequence of volumes, or
8. a sequence of {note, volume} pairs AND a sequence of durations, or
9. a sequence of {type, volume} pairs AND a sequence of notes, or
10. a sequence of notes, a sequence of types, and a sequence of volumes
11. a sequence of {interval, duration, volume} triples, or
12. a sequence of {interval, duration} pairs AND a sequence of volumes, or
13. a sequence of {interval, volume} pairs AND a sequence of durations, or
14. a sequence of {duration, volume} pairs AND a sequence of intervals, or
15. a sequence of intervals, a sequence of durations, and a sequence of volumes
16. a sequence of {interval, type, volume} triples, or
17. a sequence of {interval, type} pairs AND a sequence of volumes, or
18. a sequence of {interval, volume} pairs AND a sequence of durations, or
19. a sequence of {type, volume} pairs AND a sequence of intervals, or
20. a sequence of intervals, a sequence of types, and a sequence of volumes
21. a sequence of {octaveless note, duration, volume} triples, or
22. a sequence of {octaveless note, duration} pairs AND a sequence of volumes, or
23. a sequence of {octaveless note, volume} pairs AND a sequence of durations, or
24. a sequence of {duration, volume} pairs AND a sequence of octaveless notes, or
25. a sequence of octaveless notes, a sequence of durations, and a sequence of volumes
26. a sequence of {octaveless note, type, volume} triples, or
27. a sequence of {octaveless note, type} pairs AND a sequence of volumes, or
28. a sequence of {octaveless note, volume} pairs AND a sequence of durations, or
29. a sequence of {type, volume} pairs AND a sequence of octaveless notes, or
30. a sequence of octaveless notes, a sequence of types, and a sequence of volumes
31. a sequence of {octaveless interval, duration, volume} triples, or
32. a sequence of {octaveless interval, duration} pairs AND a sequence of volumes, or
33. a sequence of {octaveless interval, volume} pairs AND a sequence of durations, or
34. a sequence of {duration, volume} pairs AND a sequence of octaveless intervals, or
35. a sequence of octaveless intervals, a sequence of durations, and a sequence of volumes
36. a sequence of {octaveless interval, type, volume} triples, or
37. a sequence of {octaveless interval, type} pairs AND a sequence of volumes, or
38. a sequence of {octaveless interval, volume} pairs AND a sequence of durations, or
39. a sequence of {type, volume} pairs AND a sequence of octaveless intervals, or
40. a sequence of octaveless intervals, a sequence of types, and a sequence of volumes
   In the foregoing: “a sequence of notes” means an ordered sequence of musical notes (or parallel notes, or parallel notes with relative time delays/offsets), each showing the note letter and the note octave, e.g., “A #3” for “A #” in octave 3, where middle “C” is “C4”; “a sequence of octaveless notes” means an ordered sequence of musical notes each showing the note letter but not the octave, e.g., “A #”, “D”, “Eb”, . . . ; “a sequence of intervals” means an ordered sequence of distances between consecutive notes in a sequence of musical notes, where “distance” is the number of half steps, i.e., number of piano keys, between two notes; and “a sequence of octaveless intervals” means an ordered sequence of distances modulo 12 between consecutive notes in a sequence of musical notes, where “distance” is the number of half steps modulo 12, i.e., number of piano keys modulo 12, between two notes.

The rationale for using sequences of “octaveless notes” comes from the fact that it is common in human-composed music for the “same” motif to be played in different octaves, as many instruments are restricted in the note range they can play, so a given motif played by, for example, a piccolo, would need to be transposed to a lower octave for it to played on, for example, a tuba. To recognize the “same” motif in different tracks, features that are sequences of octaveless notes may be used.

Likewise, the rationale for using sequences of “intervals” comes from the fact that it is common in human-composed music for the “same” motif to be played in different keys. For example, a given motif might be played in one bar in “C major” and in another bar in “G major”, which is one key advanced clockwise on the Circle of Fifths. When a key is changed (e.g., from the key of “C” to the key of “G”) while staying in a common scale (e.g., “Major” to “Major”), the notes of the new key/scale will be transposed by a constant number of half steps relative to the notes of the original key/scale. Therefore, whereas any motif represented in terms of sequences of notes would change under such a key change, the same motif represented in terms of a sequence of intervals would be invariant to any such key change. Thus, to recognize the same motif under a uniform transposition of notes, a representation of motifs in terms of sequences of intervals may be used.

Combining the merits of the octaveless and intervallic representations results in representing motifs in terms of sequences of octaveless intervals. This is the same as a motif representation in terms of sequences of intervals, except that the interval values are now all modulo 12, which factors out any octave variation.

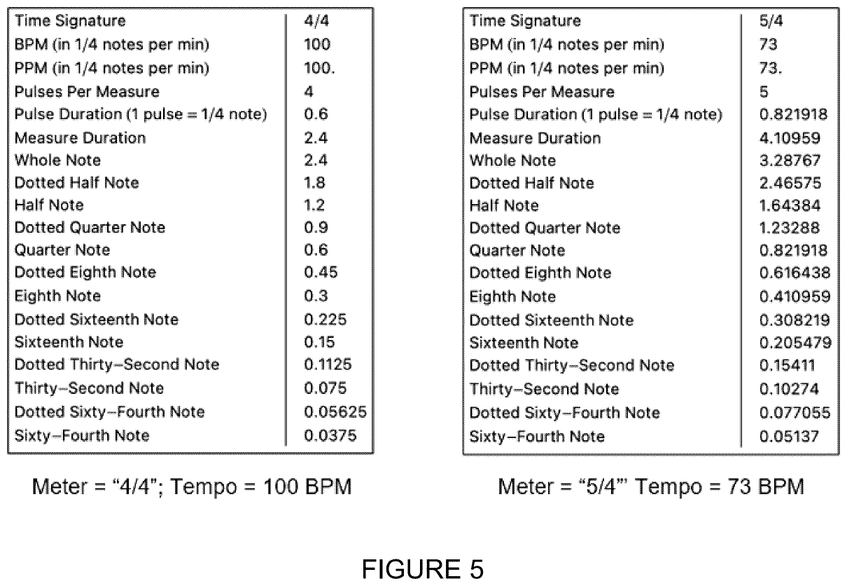

Likewise, there is some subtlety in the timing features that may be used. The note durations may be used directly; however, in aesthetic music, it is not uncommon for the same motif to be played at different tempos. Thus, relying on note durations in a motif representation could result in difficulty recognizing the same motif played at different tempos (i.e., BPM). To overcome this, it can be advantageous to use a representation of time in motifs that is stated in terms of the note types, i.e., quarter notes, eighth notes, dotted sixteenth notes etc. As the HUM representation captures the instantaneous tempo per bar (and more finely per beat interval), the instantaneous note type can be computed from the meter, tempo, and note duration. Examples of how to find which note durations correspond to which note types are seen in FIG. 5 for two exemplary cases: a 4/4 meter at 100 BPM, and a 5/4 meter at 73 BPM. Times reported in FIG. 5 are in seconds.

When the duration of each note type is known, the relationship can be inverted to ascertain which note types are present within the note duration sequence of a given motif. This, in conjunction with the instantaneous meter and tempo per bar, such as that found in HUM Patent, allows two motifs with the same note type sequence to be recognized, i.e., the same timing pattern, even if they are played at different tempos.

Some Possible Similarity Measures: In addition to defining the features that may be used to represent motifs, “similarity measures” that are appropriate for motifs represented in terms of those features may also be defined. For example, a motif representation that uses sequences of {note, duration, volume} triples may require a different similarity measure from a representation that treats motifs as sequences of notes (i.e., strings or integers), sequences of durations (i.e., reals or rationals), and sequences of volumes (i.e., reals) separately. In the former case, a similarity measure that can compare pairs of {string/integer vector, numeric vector, numeric vector} triples may be used to create one unified motif structure; whereas in the latter case three similarity measures may be needed: one that can compare pairs of string/integer vectors, and two that can compare pairs of numeric vectors, to create three motif structures-one for notes, one for durations, and one for volumes.

Generally, a complicating factor in defining a similarity measure between motifs is that the sequences of features for different motifs can differ in length. So whatever sequence measure is defined, it should advantageously be able to ascribe a numerical “similarity” score to sequences (of features) of different length, which constrains the possible choice of similarity measures. Some exemplary similarity measures are as follows:
1. Motif Similarity as “Sameness”: in some implementations, a measure of motif similarity is that a motif in track p and row q, M_pq, is only regarded as “similar” to a motif in track r and row s, M_rs, if M_pq=M_rs, i.e., they are syntactically the same, e.g., returning similarity values of 1 if syntactically the same, and 0 if not syntactically the same.
   a. This similarity measure does an excellent job recognizing exactly the same motifs in different track/bar coordinates, but cannot distinguish between motifs that are only slightly different from motifs that are grossly different.
   b. Nevertheless, given that the type(s) of features used to represent the motifs affects how the raw motif notes, durations, and volumes are mapped to the form being analysed (e.g., treating motifs as sequences of octaveless intervals already merges superficially dissimilar motifs) “sameness” is still a helpful similarity measure, and is very easy to compute.
   c. Moreover, the clustering of motifs based on similarity measure, is unnecessary in this case, as the clustering is automatic as there are only two classes, “same” and “not same”.
2. Motif Similarity as “Distance w.r.t. Distributions of Features”: in some implementations, the motif similarity measure might be based on a quantity that is inversely proportional to the distance in distribution between distributions of features computed for each motif:
   a. For example, to form such a distribution, if the representation of motifs is in terms of sequences of notes (for example), the set of unique notes may be computed for all track/bar coordinates, an index may be associated with each unique note, and then the number of occurrences of the different notes in each track/bar coordinate may be tallied to form a distribution of note counts for each track/bar coordinate. Then, the dissimilarity between motifs may be quantified at different track/bar coordinates in terms of the distance between the distributions computed for each motif. A possible similarity measure quantifying the distance between distributions is the Symmetric Kullback-Leibler (KL) Divergence (e.g., described in Harmony Patent), which may be advantageous over the standard Kullback-Leibler (KL) divergence as the latter in not symmetric, i.e., KL (dist1, dist2) yields a different distance value from KL (dist2, dist1)), whereas the Symmetric Kullback-Leibler (KL) divergence yields the same answer regardless of the order of the arguments.
   b. The idea of motif similarity measures being based on distances in distribution between distributions of features computed for different motifs generalizes readily to motifs represented in terms of features other than notes, such as, but not limited to, integers, intervals, parallel notes, durations, types, volumes, and/or tuples of such features etc.
3. Motif Similarity as “Sequence Alignment Distance”: in some implementations, a similarity measure between motifs at different track/bar coordinates may place more emphasis on the sequence of features. In can be advantageous for a motif similarity measure to be higher with a greater percentage of notes in common, and higher with a greater percentage of the common notes in the same order. A similarity measure that is inversely proportional to “Sequence Alignment Distance” accomplishes this:
   a. For example, consider the “Sequence Alignment Distance” between two sequences defined as:
      i. “Sequence Alignment Distance”=(“Alignment Dissimilarity”+ “Mismatch Dissimilarity”)/2 where
      ii. “Alignment Dissimilarity”=MaxLength(Seq1, Seq2)−(the cumulative lengths of all aligned runs of elements in an optimal alignment, “ALIGN”) and;
      iii. “Mismatch Dissimilarity”=the cumulative edit distance of all non-aligned sub-sequences in the same optimal alignment, “ALIGN”
      iv. For example:
         1. Given a motif note sequence:
         Seq1={“A4”, “E3”, “G #3”, “A3”, “B3”, “G #4”, “B4”, “A4”, “F #4”, “A3”}
         2. Given a motif note sequence:
         Seq2={“A4”, “B3”, “E3”, “A3”, “B3”, “A3”, “B4”, “A4”, “F #4”, “A3”}
         3. Optimal Alignment:
         a. Optimal sequence alignment of Seq1 and Seq2=
         {
         {“A4”}, (*** alignment run length 1 ***)
         {0, {“B3”}, (*** mismatch, edit distance 1 ***)
         {“E3”}, (*** alignment run length 1 ***)
         {“G #3”}, { }, (*** mismatch, edit distance 1 ***)
         {“A3”, “B3”}, (*** alignment run length 2 ***)
         {{“G #4”}, {“A3”}, (*** mismatch, edit distance 1 ***)
         {“B4”, “A4”, “F #4”, “A3”} (*** alignment run length 4 ***)}
         4. AlignmentDissimilarity(Seq1, Seq2)=2
         a. Proof:
         i. MaxLength(Seq1, Seq2)=10
         ii. Cumulative length of all aligned runs=1+1+2+4=8
         iii. MaxLength(Seq1, Seq2)−CumulativeLengthOfAllAlignedRuns(Seq, Seq2)=10−8=2
         5. MismatchDissimilarity(Seq1, Seq2)=3
         a. Proof:
         i. Cumulative Edit Distance of all Non-Aligned Subsequences=1+1+1=3
      v. “Sequence Alignment Distance”=(“Alignment Dissimilarity”+ “Mismatch Dissimilarity”)/2=(2+3)/2=2.5
4. Similarity as “Dynamic Time Warping Distance” (DTW Distance): in some implementations, a similarity measure may be defined between motifs at different track/bar coordinates in terms of the dynamic time warping distance. Motif similarity measures based on such a distance accommodates both the melodic and temporal aspects of a motif in one measure, i.e., “Dynamic Time Warping Distance” is including both timing information and note sequence information in a single measure, whereas the preceding “Sequence Alignment Distance” only used note sequence information. To use a DTW Distance, a motif representation in terms of a sequence of {duration, note} pairs may be mapped into a corresponding sequence of {startTime, stopTime, note} triples wherein the times (computed from cumulative durations) are relative to the start time of the bar in which the motif begins. As an example, the Euclidean Distance may be used as a measure of the distance between to temporal sequences by measuring the distance between the sequence values at common times; however, the Dynamic Time Warping Distance may allow a nonlinear stretching or distortion of time to create the best possible alignment of features. In this way, two motifs may be recognized as similar even if one has note durations different from the other, or if they are at running at different tempos. Note that unlike the aforementioned Sequence Alignment Distance the actual values of the sequence elements (the values of the vertical axis) may factor into the “Dynamic Time Warping Distance” value.

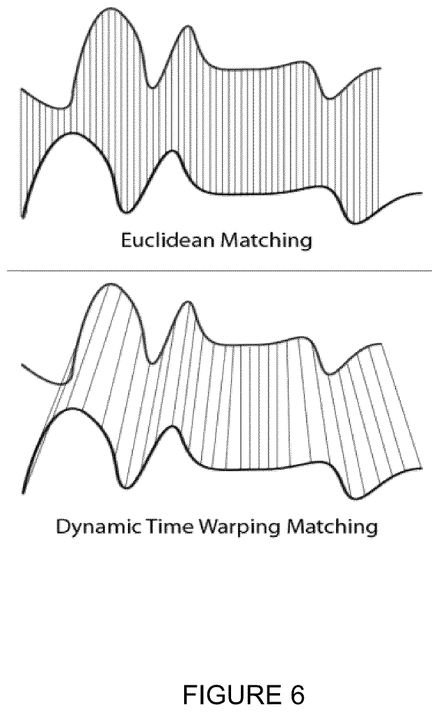

FIG. 6. shows an illustrative comparison between Euclidean Matching and Dynamic Time Warping Matching. With dynamic time warping the distance between two temporal sequences may be assessed after finding the optimal time-warping of one sequence into the other that aligns their features optimally.

To use the dynamic time warping distance measure, it can be advantageous to represent the sequences purely numerically. For example, motifs that are represented as sequences of {note, duration} pairs may be converted to equivalent sequences of {note integer, duration} pairs using the note to integer mapping rules and Dynamic Time Warping may be used to measure the similarity between two temporal time series sequences by computing the distance from the matching similar elements between two timed sequences. The result may be improved when any/all of the following are true:
a. Every index from the first sequence is matched with one or more indices from the second sequence, and vice versa
b. The first index from the first sequence is matched with the first index from the second sequence (but it could also match successive elements too)
c. The last index from the first sequence is matched with the last index from the second sequence (but it could match predecessor elements too)
d. The mapping of the indices from the first sequence to indices from the second sequence is monotonically increasing, and vice versa.
   In the usual dynamic time warping distance, the actual values of the sequence factor into the distance scores o that a sequence of note integers such as {0, 5, 3, 8, . . . } may be closer (w.r.t. dynamic time warping distance) to {0, 5, 3, 7, . . . } than {0, 5, 3, 11, . . . } (for example, where the ellipsis represents the same continuation in each sequence). However, in music, as these sequences of integers represent notes, some note intervals are more “consonant” and therefore “aurally closer” than note intervals that are more dissonant. Hence, in some implementations the use of an “Aural Dynamic Time Warping Distance” may be advantageous, wherein the distance function used to assess the optimal alignment may not only be low for similar note values, but may also be low for similar note values that differ by a consonant interval. In this case, motifs may be recognized as “similar” if their notes harmonize with those of the other motif, even if they are not exactly the same notes, or the same notes in different octaves.

### Generating Individual MOTIF Elements

In various implementations of the present systems, methods, and computer program products, one or more motif structures (including but not limited to the motif structures generated per the systems, methods, and computer program products described above) may be used to generate music. The description that follows begins with the case of creating single-track motifs, then proceeds to describe how to make these motifs mood-specific, and then mood-and-genre-specific-though a person of skill in the art will appreciate that this ordering is used for descriptive purposes only and is not intended to limit the present systems, methods, and computer program products to implementations that progress in the same order.

In the exemplary description that follows, it is assumed that the motifs are to be represented by three motif structures, one for notes (or note integers), one for durations (or note types), and one for note volumes. A person of skill in the art will appreciate that this assumption is used for descriptive purposes only and is not a limitation of the present systems, methods, and computer program products.

In the context of a single track, a motif structure may include an object similar to FIG. 3 together with the bar-level elaborations implied by FIG. 4, or a single row of FIG. 2 specifying which bars in a sequence of bars are to be assigned the same motif. For example, in a sequence of 8 bars having the pattern ABCDAT₋₂(B) C′D (see FIG. 4 for explanation of annotations) there may be 4 essential motifs, motif A, motif B, motif C, and motif D, one derived motif, i.e., T₋₂(B) (which may include a transposition of motif B down 2 half steps), and one varied motif, i.e., C′, which may include a “slight” variation, in (for example) note timing and/or note volume but not note sequence, of the original motif C. Thus, to a first approximation, it may be sufficient to generate a motif for each distinguished motif letter, namely, A, B, C, and D, and then construct the derived motifs, and then align them according to the motif structure sequence ABCDAT₋₂(B) C′D. Although this example only considers the case where the note sequence, duration sequence, and volume sequence for each motif is created independently, other implementations that allow one or more types of motif(s) to influence the generation of one or more other types of motif(s) are also possible. Motif Generators via Sequence Generators: In general, any method for generating sequences of symbols (i.e., numbers, characters, or marks), may be used to generate motifs by associating the symbols with any single or combination of notes or note integers, note durations or note types, and/or note volumes. However, such sequence generators fall into two broad classes: sequence generators that are learned, and sequence generators that are stipulated. Our methods can employ either.

a. Creating Motif Elements Via Sequence Generators that are Learned

In accordance with the present systems, methods and computer program products, sequence generators may be learned. These may work by extracting the motif features of interest from a body of pre-existing music and then building a model for generating the kinds of sequences of features seen. These features may be, e.g., {note, duration, volume} sequences, {note, duration} sequences and volume sequences, {note, volume} sequences and duration sequences, {duration, volume} sequences and note sequences, or note sequences, duration sequences, or volume sequences. Once the motif features of interest have been extracted, a model that accounts for the data may be constructed and then used to generate novel sequences.

A specific exemplary implementation of this concept is as follows: from a body of pre-existing music, learn the probability of the transition from one triple, {note_i, duration_i, volume_i}, to a next triple in the sequence, {note_j duration_j, volume_j} to form a Markovian probability matrix, and then use this matrix to generate new sequences of triples. Alternatively, from a body of pre-existing music, learn the probability of the transition between two prior triples {{note_i1, duration_i1, volume_i1}, {note_i2, duration_i2, volume_i2}-> {note_j, duration_j, volume_j} to form a 2-back Markovian probability matrix, and then use this matrix to generate new sequences of triples. Alternatively, from a body of pre-existing music, learn the probability of the transition between k prior triples {{note_i1, duration_i1, volume_i1}, {note_i2, duration_i2, volume_i2}, . . . , {note_ik, duration_ik, volume_ik}-> {note_j, duration_j, volume_j} to form a k-back Markovian probability matrix, and then use this matrix to generate new sequences of triples (e.g., in a manner similar to that described in US Patent Application Ser. No. US 2021-0241734 A1, which is incorporated herein by reference in its entirety). Likewise, in some implementations, any of these methods may be used to generate sequences of {note, duration} pairs and volumes, or {note, volume} pairs and durations, or {duration, volume} pairs and notes, or sequences of notes singly, or durations singly, or volumes singly. Some implementations may invoke or employ quantum computation, for example as described in US Patent Publication US 2022-0114994 A1, which is incorporated herein by reference in its entirety.

Some implementations may employ different sequence generators that are learned using, e.g., neural networks, or deep networks, LSTMs (long short term memory architectures), or machine learning more generally.

b. Creating Motif Elements Via Sequence Generators that are Stipulated

In some implementations, there might be no learning from pre-existing music. Instead, simply posit, define or declare a symbol sequence generator and associate the symbols with {note, duration, volume} triples, or {note, duration} pairs, or {note, volume} pairs, or {duration, volume} pairs, or note sequences, duration sequences, or volume sequences. The following provides a simple exemplary case involving the generation of corresponding note motifs, (timing) type motifs, and volume motifs, from which {note, type, volume} triples can be synthesized; however, a person of skill in the art will understand that in other implementations the present systems, methods, and computer program products may generalize to composite motif features.

c. Creating Motif Elements

Some examples of motifs generated by stipulated sequence generators, and the details of those generators, are as follows:
1. Timing Motifs Generated from a Finite Set of Note Types:
   a. Given:
      i. the goal of a motif represented as a note type sequence (i.e., a sequence of note timings expressed in terms note types such as quarter note (1/4), eighth note (1/8), dotted eighth note (3/16), etc.
      ii. a target time signature (or meter), e.g., 7/8 (seven eighth notes per measure or bar)
      iii. a yes/no choice whether or not to align the temporal durations of notes to the boundaries of each bar. In this example, “yes” is chosen. The latter choice introduces an implied constraint on an acceptable solution, namely, that the sum of all note types must equal 7/8 exactly. If the choice was “no” motif timings would be allowed to extend beyond the duration of the measure (a.k.a. bar).
   b. Method:
      i. Define the set all note types <=7/8, i.e., all fractions of the form i/2\hat{ }j that are less than or equal to 7/8, (where i, j are non-negative integers within some musically sensible range such as 1<=i<=12 (for example) and 0<=j<=5 (for example). Call this set S.
      ii. S_1<-OneOf(S) (*** pick an element of S, call it S_1 ***)
      iii. While (SUM (S_1+ . . . . S_i)<7/8, (*** sum of picks so far <7/8 ***) S_(i+1)<-OneOf(S)); (*** pick another ***) S<-RESTRICT S to note types <=(7/8)−SUM (S_1+ . . . . S_i)))
      iv. Return (S_1, S_2, . . . , S_(i+1))
      v. TEST: if SUM (S_1+ . . . +S_(i+1)=7/8 return (S_1, S_2, . . . , S_(i+1)) and terminate; else GOTO STEP 1
   c. Observation: in this example, random selection is used, subsequent restriction on remaining selections is used, and then a final test as to whether the sum of the note types, add up to 7/8 exactly is carried out.
   d. In some implementations, a partial re-ordering of the output note type sequence may be chosen, wherein the longest duration note type is moved to the end of the sequence. Motif timings can sometimes be more aesthetic if they terminate on a longer note. Motifs that terminate on a short note can sometimes sound less humanlike.
2. Note Motifs Generated from a Finite Set of Notes:
   a. Given:
      i. the goal of a motif represented as a note sequence
      ii. a restricted set of notes {n_1, n_2, . . . } from which the motif notes are to be selected
      iii. (optionally) a desired set of non-negative numbers, or biases, or weights, {w_1, w_2, . . . }, s.t. the probability, p_i, with which note n_i is selected is p_i=w_i/(SUM (w_1, w_2, . . . ). Note, if no weights are specified, a uniform set of weights is assumed corresponding to unbiased selection.
      iv. a target number, k, of notes in the motif to be generated
   b. Method:
      i. Repeat k times: select a note from the set {n_1, n_2, . . . } with relative weight {w_1, w_2, . . . }, i.e., note n_i is returned with probability p_i.
      ii. Return the notes selected in the order selected.
   c. Observation: this generation method only uses notes from the restricted set {n_1, n_2, . . . } and no others.
   d. In some implementations, the present systems, methods, and computer program products may be supplemented with a “reversion bias” by adapting the probabilistic selection of notes by adjusting the weights (biases) if the developing note sequence is starting to stray to too high or too low a note value. For example, notes that are lower than preceding notes might be preferred, if the preceding notes have accumulated a net intervallic shift exceeding (for example) 1.5 octaves up or down from their starting point.
3. Note Motifs Generated from a Finite Set of Note Intervals:
   a. Given:
      i. the goal of a motif represented as a note sequence
      ii. a restricted set of note intervals {int_1, int_2, . . . } from which the motif intervals are to be selected
      iii. (optionally) a desired set of non-negative numbers, or biases, or weights, {w_1, w_2, . . . }, s.t. the probability, p_i, with which note interval int_i is selected is p_i=w_i/(SUM (w_1, w_2, . . . ). Note, if no weights are specified, a uniform set of weights is assumed corresponding to unbiased selection.
      iv. a target number, k, of notes in the motif to be generated
      v. a starting note, n
   b. Method:
      i. Repeat k−1 times: select a note interval from the set {int_1, int_2, . . . } with relative weight {w_1, w_2, . . . }, i.e., note interval int_i is returned with probability p_i.
      ii. Given the starting note, n, and the length (k−1) note interval sequence created in step (i), recursively add each successive note interval to the preceding note generated, and return the resulting sequence of k notes in the order generated
   c. Observation: this generation method does not necessarily constrain the notes to a certain set of notes, or a certain key/scale.
   d. In some implementations, the present systems, methods, and computer program products may be supplemented by adapting the probabilistic selection of note intervals by adjusting the weights (biases) if the developing note interval sequence is starting to stray to too high or too low a note value. For example, note intervals that are negative might be preferred if the accumulation of note intervals so far is greater than say 1.5 octaves.
4. Note Motifs Generated from a Finite Set of Motif Mood Labels: An exemplary method to achieve the creation of a certain motif mood (i.e., a mood associated with a certain melodic line, which is distinct from an ambient mood) is to restrict the set of note intervals (but not necessarily notes) that are used in the motif. As specific examples, the following note intervals may be used in achieving the following “motif moods”:
   a. “Unison”
      i. “Steadfastness”
      ii. “Constancy”
      iii. “Unwavering”
      iv. . . . and synonyms thereof
   b. “MinorSecond”
      i. “Suspense”
      ii. “Darkness”
      iii. “Displeasure”
      iv. “Anguish”
      v. “Melancholy”
      vi. and synonyms thereof
   c. “MajorSecond”
      i. “Happiness”
      ii. “Lightness”
      iii. “Neutral”
      iv. . . . and synonyms thereof
   d. “MinorThird”
      i. “Tragedy”
      ii. “Sadness”
      iii. “Uplifting”
      iv. . . . and synonyms thereof
   e. “MajorThird”
      i. “Joy”
      ii. “Hope”
      iii. “Friendly”
      iv. “Bright”
      v. “Comfortable”
      vi. and synonyms thereof
   f. “PerfectFourth”
      i. “Serene”
      ii. “Angelic”
      iii. “Light”
      iv. . . . and synonyms thereof
   g. “Tritone”
      i. “Violence”
      ii. “Danger”
      iii. “Wickedness”
      iv. “Horror”
      v. “Devils”
      vi. “Devilish”
      vii. and synonyms thereof
   h. “PerfectFifth”
      i. “Cheerfulness”
      ii. “Stability”
      iii. “Power”
      iv. “Home”
      v. “Gothic”
      vi. and synonyms thereof
   i. “MinorSixth”
      i. “Anguish”
      ii. “Sadness”
      iii. and synonyms thereof
   j. “MajorSixth”
      i. “Childlike Joy”
      ii. “Innocence”
      iii. and synonyms thereof
   k. “MinorSeventh”
      i. “Strangeness”
      ii. “Mystery”
      iii. “Eeriness”
      iv. . . . and synonyms thereof
   l. “MajorSeventh”
      i. “Aspiration”
      ii. “Displeasure”
      iii. “Longing”
      iv. . . . and synonyms thereof
   m. “Octave”
      i. “Openness”
      ii. “Completeness”
      iii. “Lightheartedness”
      iv. . . . and synonyms thereof
         Some implementations of the present systems, methods, and computer program products use specific intervallic movements between the notes of a motif (i.e., melodic phrase) to imbue it with certain desired moods. Other implementations may use specific chords, chord types, chord type transitions, and/or key/scales to create certain ambient moods. Knowledge of the aforementioned associations between motif mood labels and note intervals may be used to create a motif having a desired mood (or moods).
a. Given:
   i. the goal creating a motif conveying one or more moods
   ii. a target set of motif moods, {mood_1, mood_2, . . . }
   iii. (optionally) a desired set of non-negative numbers, or biases, or weights, {w_1, w_2, . . . }, with which each mood label mood_i is weighted relative to the other mood labels. Note, if no weights are specified, a uniform set of weights is assumed corresponding to evenly balanced moods.
   iv. a target number, k, of notes in the motif to be generated
   v. a starting note, n
b. Method:
   i. For each mood label, mood_i, lookup its associated note intervals, {int_i1, int_i2, . . . }, and weight each note interval with weight w_i, i.e., for each mood label, form mood_i-> {w_i->int_i1, w_i->int_i2 . . . }
   ii. Combine the weighted intervals into one set, i.e., form {w_1->int_11, w_1->int_12, . . . , w_2->int_21, w_2->int_22, . . . }, and aggregate the weights of any common note intervals from different mood labels. For example, if int_12 was the same interval as int_22 (say), form {(w_1+w_2)->int_11, w_1->int_12, . . . , w_2->int_21, . . . }, and rewrite this as {W_1->INT_1, W_2->INT_2, . . . } where W_1=(w_1+w_2), W_2=w_1, INT_1=int_11, INT_2=int_12, etc.
   iii. Repeat k−1 times: select a note interval from the set {INT_1, INT_2, . . . } with relative weight {W_1, W_2, . . . }, i.e., note interval INT_i is returned with probability P_i.
   iv. Given the starting note, n, and the length (k−1) note interval sequence created in step (iii), recursively add each successive note interval to the preceding note generated, and return the resulting sequence of k notes in the order generated
c. Observation: this motif generation method creates a motif having a weighted combination of the given moods. Note that the method does not necessarily constrain the notes to a certain set of notes, or a certain key/scale.
d. The creation of motif mood may be further enhanced by specifying (in addition to intervallic movements), certain other attributes of a motif, including but not limited to, e.g., its tempo, meter, instrumentation, volume etc.
5. Note Motifs Generated from the Notes of a Given Key/Scale: to create musical motifs that harmonize with a given key and scale, or a given sequence of key scales, motifs that use only notes from prescribed keys and scales may be created as follows:
   a. Given:
      i. the goal of a motif represented as a note sequence
      ii. a desired key & scale, e.g., key=“F #”, scale=“NaturalMinor”
      iii. a desired note range [minNote, maxNote]
      iv. a target number, k, of notes in the motif to be generated
      v. (optionally) a desired set of non-negative numbers, or biases, or weights, {w_1, w_2, . . . }, s.t. the probability, p_i, with which the i-th note of the given key and scale in the given note range, [minNote, maxNote], is selected is p_i=w_i/(SUM (w_1, w_2, . . . ). Note, if no weights are specified, a uniform set of weights is assumed corresponding to unbiased selection.
   b. Method:
      i. Compute all notes of the key and scale that lie in the note interval spanned by [minNote, maxNote], call this set {n_1, n_2, . . . }
      ii. Use Method #2 “Note Motifs Generated from a Finite Set of Notes” above with the restricted set being the notes {n_1, n_2, . . . } and the weights being as given.
   c. Observation: this generation method cannot dictate which note intervals are obtained in the output, and so cannot guarantee the achievement of a specific “motif mood”.
6. Note Motifs Generated from the Notes of a Given Chord: to create musical motifs that harmonize with a given key and scale, or a given sequence of keys/scales, motifs that use only notes from prescribed keys and scales may be created as follows:
   a. Given:
      i. the goal of a motif represented as a note sequence
      ii. a desired chord
      iii. a desired note range [minNote, maxNote]
      iv. a target number, k, of notes in the motif to be generated
      v. (optionally) a desired set of non-negative numbers, or biases, or weights, {w_1, w_2, . . . }, s.t. the probability, p_i, with which the i-th note of the given chord in the given note range, [minNote, maxNote], is selected is p_i=w_i/(SUM (w_1, w_2, . . . ). Note, if no weights are specified, a uniform set of weights is assumed corresponding to unbiased selection
   b. Method:
      i. Compute all notes of the chord that lie in the note interval spanned by [minNote, maxNote], call this set {n_1, n_2, . . . }
      ii. Use Method #2 “Note Motifs Generated from a Finite Set of Notes” above with the restricted set being the notes {n_1, n_2, . . . } and the weights being as given.
   c. Observation: this generation method only uses the notes of the given chord within the given note range. Therefore, such motifs are guaranteed to harmonize well with the same chord played simultaneously in other tracks.
7. Note Motifs Generated from the Notes of a Given Key/Scale and an Impending Key/Scale: to create musical motifs in a first bar that harmonizes predominantly with a first key/scale, and leads harmoniously into a subsequent motif in a second bar that harmonizes predominantly with a second key/scale, it may be advantageous to “borrow” notes from the second key/scale and use them within the motif that is harmonized predominantly to the first key/scale. Such motif pairs help transition from one key/scale to another key/scale. Such transitional motifs may be created as follows:
   a. Given:
      i. the goal of a motif represented as a note sequence
      ii. a first key & scale, e.g., key1=“F #”, scale1=“NaturalMinor”
      iii. a subsequent second key & scale, e.g., its parallel major, key2=“F #”, scale=“Major”
      iv. a desired note range [minNote, maxNote]
      v. a target number, k, of notes in the motif to be generated
      vi. (optionally) a desired set of non-negative numbers, or biases, or weights, {w_1, w_2, . . . }, s.t. the probability, p_i, with which the i-th note of the combined key1/scale1 and key2/scale2 in the given note range, [minNote, maxNote], is selected is p_i=w_i/(SUM (w_1, w_2, . . . ). Note, if no weights are specified, a uniform set of weights is assumed corresponding to unbiased selection.
   b. Method:
      i. Compute all notes of the key1/scale1 and key2/scale2 that lie in the note interval spanned by [minNote, maxNote], call this set {n_1, n_2, . . . }
      ii. Use Method #2 “Note Motifs Generated from a Finite Set of Notes” above with the restricted set being the notes {n_1, n_2, . . . } and the weights being as given.
   c. Observation: this generation method allows notes to be borrowed from a second key/scale and used within a motif in a predominantly first key/scale.
8. Note Motifs Generated from the Notes of a Given Chord and an Impending Chord: to create musical motifs in a first bar that harmonizes predominantly with a first chord, and leads harmoniously into a subsequent motif in a second bar that harmonizes predominantly with a second chord, it may be advantageous to “borrow” notes from the second chord and use them within the motif that is harmonized predominantly to the first chord. Such motif pairs help transition from one chordal harmony to another chordal harmony. Such transitional motifs may be created as follows:
   a. Given:
      i. the goal of a motif represented as a note sequence
      ii. a first chord, chord1
      iii. a subsequent second chord, chord2
      iv. a desired note range [minNote, maxNote]
      v. a target number, k, of notes in the motif to be generated
      vi. (optionally) a desired set of non-negative numbers, or biases, or weights, {w_1, w_2, . . . }, s.t. the probability, p_i, with which the i-th note of the combined chord1 and chord2 in the given note range, [minNote, maxNote], is selected is p_i=w_i/(SUM (w_1, w_2, . . . ). Note, if no weights are specified, a uniform set of weights is assumed corresponding to unbiased selection.
   b. Method:
      i. Compute all notes of chord1 and all notes of chord2 that lie in the note interval spanned by [minNote, maxNote], call this set {n_1, n_2, . . . }
      ii. Use Method #2 “Note Motifs Generated from a Finite Set of Notes” above with the restricted set being the notes {n_1, n_2, . . . } and the weights being as given.
   c. Observation: this generation method allows notes to be borrowed from a second chord and used within a motif in a predominantly a first chord, to achieve a more sophisticated harmonic movement from one bar to the next bar.
9. Note Motifs Generated from a Given Colored Noise Model: Exemplary systems, methods, and computer program products for generating sequences of notes (or note integers or note intervals), note durations (or note types), and note volumes allow selection based on the projection of values from an underlying stochastic process, such as but not limited to, a noise process, or more specifically a colored noise process. The rationale for pursuing this approach lies in the fact that the spectral density and autocorrelation of various colored noise processes mimics those found in nature, and in some cases can result in aesthetic musical sequences that are neither too random, nor too regular. The present systems, methods, and computer program products describe the use of such colored noise models as sequence generators. As an example, the generator may be specialized to make sequences of notes, but as before, the same techniques could be used to generate other sequences of motif features, and indeed, sequences of tuples of motif features. Moreover, in the following, a motif is assume to last the length of one measure, but more generally it could last longer.
   a. Given:
      i. the goal of a motif represented as a note sequence
      ii. a time signature (a.k.a. meter)
      iii. a tempo (a.k.a. beats per minute, or BPM)
      iv. a key and a scale (or a chord)
      v. a desired note range [minNote, maxNote]
      vi. a colored noise generator (with (optionally) a preferred sample rate)
      vii. a desired noise color, e.g., “White”, “Brown”, “Pink”, “Blue”, “Intermediate”
      viii. a projection operator from sampled noise values to notes
      ix. a target number, k, of notes in the motif to be generated
   b. Method:
      i. Using the time signature (meter) and tempo, compute the duration of one measure, this will be the duration of a motif spanning one bar.
      ii. Generate a set of k note types (and their corresponding durations), that partition the measure. For example, if the time signature is 4/4, one measure may contain 4 quarter notes, or 3 quarter notes and 2 eighth notes, or a dotted quarter note and 5 eighth notes, etc. NOTE: it may be acceptable for a note to extend beyond of the end of the measure, in which case the sum of all note types can exceed 4/4=1, but all k notes should start within the measure, and the first note should start at the start of the measure
      iii. Generate a sample (at the (optional) preferred sample rate) of the noise produced by the colored noise generator of the desired color over a period of time equal to the temporal duration of one measure
      iv. Measure the value of the sampled noise at the start time of each of the k notes, retain the results as the “sample values”
      v. Use the projection operator, to map the “sample values” to corresponding notes of the given key/scale, or the given chord, in the range [minNote, maxNote]
      vi. Return the resulting sequence of {note, startTime, duration} triples for all k notes.
   c. Different Color Noise Generators: the various implementations described herein include implementations that work for many different colored noise generators, although some noise generators, specifically “Pink” or “Intermediate” noise, may yield more aesthetic results. The various colored noise generators differ how their power spectral density scales with frequency, f. For example:
      i. “White Noise”: power spectral density is constant, i.e, follows 1/(f\hat{ }0)
      ii. “Pink Noise”: power spectral density follows 1/f
      iii. “Blue Noise”: power spectral density follows f
      iv. “Brown Noise”: power spectral density follows 1/(f\hat{ }2)
      V. “Intermediate Noise”: power spectral density follows 1/(f\hat{ }alpha)−2<=alpha <=+2 for

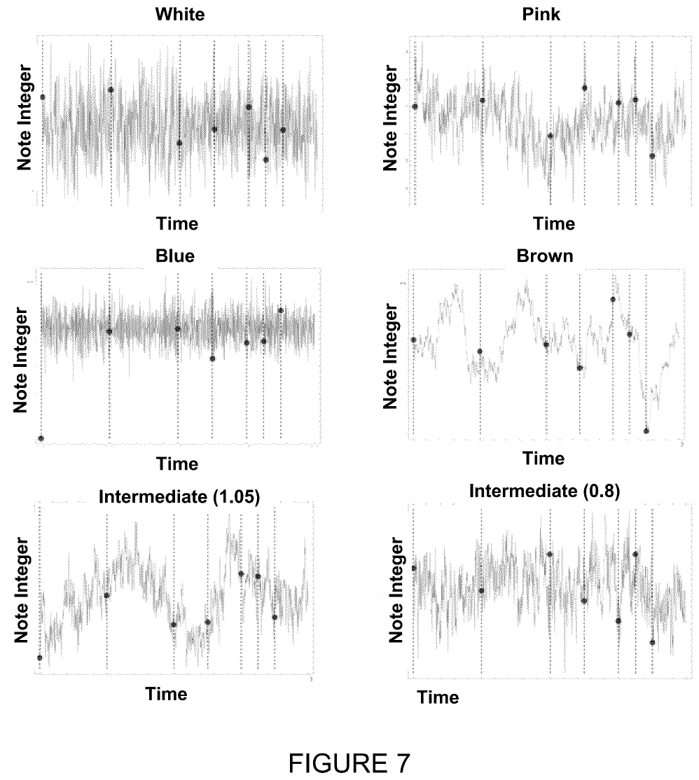

FIG. 7 shows illustrative examples of 6 different noise models used for the purpose of creating a musical motif. In each case, there is a red dot at the sample time (horizontal axis), and showing the resulting sampled value (vertical axis). The latter is rounded to the nearest note integer of the desired key/scale (in this case “G”, “Natural Minor”). Each model is labeled with the noise color used. All examples use a sample rate of 1000 Hz, and pertain to a 4/4 motif at 120 BPM. The same note type (i.e., note timing) sequence is used in each case for exemplary purposes, wherein the note types are quarter note, quarter note, eighth note, eighth note, sixteenth note, sixteenth note, eighth note, which translates into sample times of 0, 0.5, 1.0, 1.25, 1.5, 1.625, 1.75 seconds. Note that the bottom two examples are “Intermediate” color noise, with alpha=1.05, and alpha=0.8 respectively. Aesthetically, “Intermediate” and “Pink” noise seem to give the most humanlike sounding motifs, having a nice balance between randomness and regularity.
10. Note Motifs Generated from Preferred Consonances: In some implementations, note motifs may be generated from finite sets of notes, finite sets of note intervals, motif moods, specific key/scales, specific chords, and modulating key/scales, and modulating chords. In some implementations, more explicit control over the consonance qualities of our musical motifs may be employed. For example, to generate music for a horror movie, mostly dissonant intervals might be sought. The example that follows describes how to generate note motifs with controllable consonance properties.

The intrinsic consonance quality of all note intervals in the audible range may be defined. In some implementations, the intrinsic consonance quality of an interval may be the same whenever the note interval is incremented (or decremented) by 12 half-steps. Therefore, each note interval in the audible range may be associated with a 4-tuple comprising a note interval (modulo 12), a named interval, a consonance quality label, and a consonance quality score. For example, define:
a. Intrinsic Consonance Quality of Note Interval i: for each note interval define the 4-tuple {interval (mod 12), interval name, consonance label, consonance score}
   i. A note interval modulo 12, (i mod 12)
   ii. The corresponding named interval
   iii. An intrinsic consonance quality label (which repeats ever 12 half-steps)
   iv. An intrinsic consonance quality score (which repeats ever 12 half-steps)

The note interval, i, is any integer from 0 to 127, which spans any possible interval in the audible range. The corresponding named interval may be dictated by the note interval modulo 12, i.e., from the value of i mod 12, and can range from “Unison” (for a note interval of 0), through “Minor Second”, “Major Second”, “Minor Third”, “Major Third”, “Perfect Fourth”, “Tritone”, “Perfect Fifth”, “Minor Sixth”, “Major Sixth”, “Minor Seventh”, “Major Seventh”, to “Octave” (for a note interval any integer multiple of 12). The consonance quality label may depend on the named interval, and ranges from “Strongly Dissonant” to “Strongly Consonant”. The intrinsic consonance quality score may associate a numeric value between 0 and 1 with each consonance quality label, where 0 corresponds to “Strongly Dissonant” and 1 corresponds to “Strongly Consonant”. A specific proposal for a set of intrinsic consonance quality 4-tuples is given below. It is understood that the consonance quality labels, and/or numeric values for consonance quality scores, are only exemplary, and other values could be used. In some implementations, consonance quality 4 tuples may be defined as follows:
a. Intrinsic Consonance Quality 4-Tuple for Note Interval i:

| | | |
|---|---|---|
| i. | i = 0: | {0, ″Unison″, ″Consonant″, 0.667}, |
| ii. | (i mod 12) = 1: | {1, ″Minor Second″, ″Strongly Dissonant″, 0}, |
| iii. | (i mod 12) = 2: | {2, ″Major Second″, ″Less Dissonant″, 0.15}, |
| iv. | (i mod 12) = 3: | {3, ″Minor Third″, ″Strongly Consonant″, 1}, |
| v. | (i mod 12) = 4: | {4, ″Major Third″, ″Strongly Consonant″, 1}, |
| vi. | (i mod 12) = 5: | {5, ″Perfect Fourth″, ″Mildly Dissonant″, 0.5}, |
| vii. | (i mod 12) = 6: | {6, ″Tritone″, ″Dissonant″, 0.333″}, |
| viii. | (i mod 12) = 7: | {7, ″Perfect Fifth″, ″Strongly Consonant″, 1}, |
| ix. | (i mod 12) = 8: | {8, ″Minor Sixth″, ″Mildly Dissonant″, 0.5}, |
| x. | (i mod 12) = 9: | {9, ″Major Sixth″, ″Consonant″, 0.667}, |
| xi. | (i mod 12) = 10: | {10, ″Minor Seventh″, ″Mildly Dissonant″, 0.5}, |
| xii. | (i mod 12) = 11: | {11, ″Major Seventh″, ″Dissonant″, 0.333}, |
| xiii. | (i mod 12) = 0 | {0, ″Octave″, ″Strongly Consonant″, 1}} |
| | and i ! = 0: | |

As the consonance qualities repeat every 12 half-steps, the above definitions in (a)-(m) imply consonance qualities for all audible intervals. For example, the consonance quality of the note interval 17 would be {“Perfect Fourth”, “Mildly Dissonant”, 0.5} because for note interval i=17, (17 mod 12)=5, and so clause (vi) above applies.

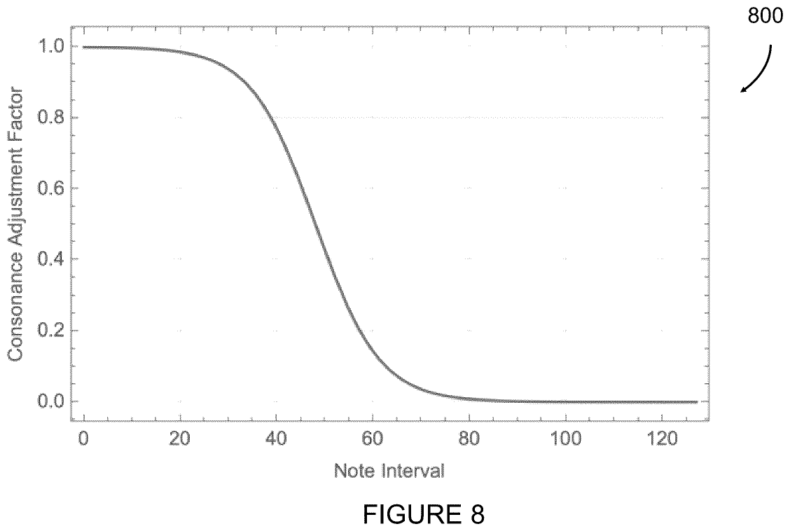

In some implementations, the consonance quality scores may depend on both the note interval modulo 12, and the absolute size of the note interval. The motivation for such an adjustment comes from the fact that note changes over excessively larger intervals sound less consonant even if the intrinsic consonance quality of that interval is high. Thus, in some implementations:
a. Adjusted Consonance Quality of Note Interval i: for each note interval, define the 4-tuple {interval (mod 12), name, consonance label, consonance score}
   v. A note interval modulo 12, (i mod 12)
   vi. The corresponding named interval
   vii. A consonance quality label (which repeats ever 12 half-steps)
   viii. An adjusted consonance quality score (which modifies the intrinsic consonance score by multiplying it by some factor that declines with increasing note interval)
      This modification is intended to capture the notion that the consonance of excessively large intervals is diminished somewhat if the intervals become too large. For example, consider the function of note interval, i, defined by f(i)=1−logistic (0.15(i−48)), where logistic(x)=1/(1+exp(−x)) for any argument x. This function, has the form showing FIG. 8. FIG. 8 shows a graph of f(i)=1−logistic (0.15(i−48)) where i is the absolute value of the note interval, and logistic(x)=1/(1+exp(−x)) for any argument x. Multiplying the consonance quality score of note interval i by f(i) captures the intuition that note intervals become less consonant the larger the interval, regardless of the intrinsic consonance quality of the interval. The choice of the exemplary nonlinear function f(i) in FIG. 8 allows the consonance quality scores to be largely unchanged until note intervals that span more than two octaves are reached. The specific choice of f(i) is exemplary and other implementations could make use of different functional forms for f(i).

The aforementioned relationships between note intervals and their (intrinsic or adjusted) consonance quality scores may be used to generate motif note sequences that are more or less consonant.
a. Given:
   i. the goal of a motif represented as a note sequence
   ii. a restricted set of notes {n_1, n_2, . . . } from which the motif notes are to be selected
   iii. a desired mean adjusted consonance quality score and (optionally) a desired variance in the adjusted consonance quality score
   iv. (optionally) a desired set of non-negative numbers, or biases, or weights, {w_1, w_2, . . . }, s.t. the probability, p_i, with which note n_i is selected is p_i=w_i/(SUM (w_1, w_2, . . . ). Note, if no weights are specified, a uniform set of weights may be assumed corresponding to unbiased selection.
   v. a target number, k, of notes in the motif to be generated
b. Method:
   i. Repeat k times: select a note from the set {n_1, n_2, . . . } with relative weight {w_1, w_2, . . . }, i.e., note n_i is returned with probability p_i, to yield a note sequence. Call this sequence, {m_1, m_2, m_3, . . . }
   ii. Next compute the average consonance quality score for the returned sequence {m_1, m_2, m_3, . . . } as follows:
      1. Convert the note sequence {m_1, m_2, m_3, m_4 . . . } into an equivalent note integer sequence {i_1, i_2, i_3, i_4 . . . };
      2. Partition the note integer sequence {i_1, i_2, i_3, i_4 . . . } into pairs with an offset of 1, i.e., form the pairs {j_1, i_2}, {i_2, i_3}, {i_3, i_4}, . . . etc;
      3. Compute the absolute value of the differences to form the sequence of absolute values of the note intervals, i.e., form |i_2−i_1|, |i_3−i_2|, |i_4−i_3|, . . . etc.;
      4. Convert each note interval to a corresponding intrinsic consonance quality to yield score (|i_2−i_1|), score (|i_3−i_2|), score (|i_4−i_3|), . . . , score (|i_(k)−i_(k−1)|);
      5. (Optional) multiply each intrinsic consonance quality score by the appropriate interval-dependent scaling factor, score (|i_2−i_1|)*f(|i_2−i_1|), score (|i_3−i_2|)|)*f(|i_3−i_2|), score (|i_4−i_3|)|)*f(|i_4−i_3|), . . . , score (|i_(k)−i_(k−1)|)|)*f(|i_(k)−i_(k−1)|);
      6. Compute the mean (and optionally variance) consonance quality scores
   iii. IF the mean (and optionally the variance) of the adjusted consonance quality scores are close to the desired targets, then stop and return {m_1, m_2, m_3, m_4 . . . }, ELSE go to step 1.
c. In some implementations, a large number, N, of permutations of the single answer, {m_1, m_2, m_3, m_4 . . . }, may be generated and the mean (and optionally variance) of the adjusted consonance quality scores for each permutation may be re-computed, picking the permutation that most closely matches the target mean adjusted consonance quality score and (optionally) the target variance of the adjusted consonance quality scores.
d. Some implementations may forgo specific targets on the mean (and optionally the variance) of the adjusted consonance quality scores. Instead, a large number, N, of permutations of the single answer, {m_1, m_2, m_3, m_4 . . . }, may be generated and the mean (and optionally variance) of the adjusted consonance quality scores for each permutation may be re-computed, and the permutation of {m_1, m_2, m_3, m_4 . . . } that is most consonant may be selected.
e. In some implementations the restricted set of notes {n_1, n_2, . . . } from which the motif notes are to be selected might come from a specific key/scale, or both a first key/scale and a second key/scale. The latter might apply if it is desired to create a motif having specific consonance properties and which modulates from one key/scale to another.
f. In some implementations the restricted set of notes {n_1, n_2, . . . } from which the motif notes are to be selected might come from a specific chord, or both a first chord and a chord. The latter might apply if it is desired to create a motif having specific consonance properties and which modulates from one chord to another.
11. Note Motifs Generated with the Assistance of Constraints, Restrictions or Tests: It can be difficult to create motif generators that output only human-quality aesthetic motifs at every attempt. In such cases, an alternative strategy may include:
   i. Define a set of criteria against which to evaluate the degree to which a motif is aesthetic;
   ii. Generate multiple motifs;
   iii. Test each motif against the pre-defined criteria;
   iv. Terminate the generation process if an acceptable motif is found, or restart it afresh if not.

In some implementations a motif might be scored against the following criteria:
a. Notes Confined to a Range Spanning Roughly an Octave-and-a-Half: The range of notes within the motif must not be too large or too small, but rather limited to, for example, an octave-and-a-half.
   i. Operational Test: compute the note range of the motif and test it spans no more than 18 half steps.
b. Contains Repeating Elements in Notes, Intervals, or Timing: There may be sequences of repeated notes, sequences of repeated note intervals, and/or sequences of repeated note types (or durations). Such repetition of substructure within the motif provides a degree of coherence distinguishing it from a purely random pattern.
   i. Operational Test: compute the longest repeating subsequence within a motif, and/or in each component of a motif separately. If the result is non-trivial (i.e., longer than a handful of elements) the motif has substructure.
c. Uses Predominantly Stepwise Motion: The melodic line of the motif may move predominantly by stepwise motion (up or down) amongst the notes of a specific key/scale, the notes of a specific chord, or notes of a specific chord augmented with a small number of notes that lie a consonant interval above the notes of the specific chord.
   i. Operational Test: compute the sequence of note intervals between successive notes of the motif, and verify that their distribution is predominantly weighted to small numbers of steps.
d. Uses Infrequent Larger Intervallic Leaps, and Volume Surges: The melodic line of the motif may use an occasional note interval that is large compared to the average note interval in the motif, is typically a consonant interval above a preceding note, and is typically accompanied by a concomitant surge in note volume.
   i. Operational Test: compute the sequence of note intervals between successive notes of the motif, and verify that their distribution contains an outlier single large interval, that is a consonant interval above the preceding note, and has a louder than average associated note volume.
e. Transient Consistent Directional Trends in Note Motion Between Different Tracks: good motifs typically have consistent directional note motions between different tracks of the same bar. The motions can be categorized broadly as:
   1. Parallel motion: the notes of a first track move broadly in the same pattern as the notes of a second track over the same time interval;
   2. Contrary motion: the notes of a first track move broadly in an anti-correlated pattern compared to the notes of a second track over the same time interval;
   3. Ascending motion: the notes two tracks both ascend over the same time interval;
   4. Descending motion: the notes of two tracks both descend over the same time interval;
   5. Oblique motion: the notes of a first track remain broadly constant, while those of a second track ascend, descend, of follow a more dynamic pattern over the same time interval;
   i. Operational Test: compute the correlation between the (start time, note integer) pairs of the motifs in any two tracks to determine if they are correlated (which implies parallel motion, ascending motion, or descending motion and a further check on monotonicity and pitch trend can distinguish these cases), anti-correlated (which implies contrary motion), or uncorrelated (which implies oblique motion).
f. Has a Climactic Point Followed by a Descent to a Tonic: good motifs typically build up to a climatic high-point, that is associated with a longer held, louder, higher pitched note, occurring on a strong beat, which is played with a sustained harmony of long duration consonant chord notes, after which he motif descends to a play where it can naturally end or repeat.
   i. Operational Test: Test for a high pitch long loud note beginning at the time of a strong beat (given the meter), and accompanied by sustained consonant notes (possibly in other tracks), followed by a note descent to a tonic note (for the give key/scale).

Any of the aforementioned motif generation techniques might be used with a looping construct that uses such constraints, restrictions or tests.
12. Motifs Generated with Post-Processing: any of the above systems, methods, and computer program products for generating a motif, or generating a component of a motif, can be augmented with a post-processing step, wherein an operation is performed on the output motif (as created) to yield a superior motif. Specific examples are as follows:
   a. Post-Processing a Note Sequence: a note sequence may be post-processed to find a re-ordering of the same notes that reduces the mean and/or variance of the note intervals. The rationale is that note sequences that move in small steps are generally more humanlike and aesthetic.
   b. Post-Processing a Note Type (Timing) Sequence: timing information may be post-processed by, given a raw output note type sequence, selectively moving the longest note type to the end of the sequence. The rationale is that motifs that end on longer notes tend to sound more humanlike and aesthetic.
   c. Post-Processing a Note Volume Sequence: a note volume sequence may be post-processed to move the loudest volume to the highest longest note. The rationale is that this tends to create a climax in the motif making it more humanlike and aesthetic.
      Generating Single-Track Music in Targeted Ambient Mood(S), and/or Desired Key/Scale(S), and/or Genres, Using a Motif Structure
a. Create Single-Track Motifs in a Targeted Ambient Mood Using a Motif Structure
   1. Given:
      a. The goal of generating a single track of music having a desired mood
      b. a target ambient mood
      c. a motif structure, M={Motif_1, Motif_2, . . . , Motif_N}, (see for example FIG. 3) which specifies (a) the number of bars (N) and (b) the number tracks (1 in this case), and (c) which bar/track coordinates are deemed the “same” motif, i.e., which motifs Motif_i and Motif_j are deemed to be the “same”.
      d. (optionally) a time signature, a tempo, and an instrument. Alternatively, the time signature, and/or the tempo, and/or the instrument might be computed from the mood.
   2. Method:
      a. Compute the number of distinct motifs, k, in the motif structure, i.e., the minimal subset of the motifs from the motif structure, M, such that no two motifs in the subset are the same. Note that this step determines the parameter, k.
      b. Generate a mood-specific chord progression, Chord_1, Chord_2, . . . , Chord_k of length k chords for the given mood (e.g., as described in Mood Sequence Patent).
      c. Assign motif placeholders to chords. Starting from the first motif, Motif_1, assign Motif_1 and all motifs equivalent to it (if any according to the motif structure) to the first chord, Chord_1, of the length k chord progression. Then move on to the next motif in order that is not yet assigned a chord. Assign this first “not-yet-assigned” motif the next chord Chord_2. Repeat this process of assigning the next unassigned motif (and all those equivalent to it) to the next chord in the chord progression, until all motifs have been assigned chords, and all k chords have been used. The resulting sequence of assignments may then be: {Motif_1->Chord_1, . . . . Motif_p->Chord_q, . . . }
      d. Generate a motif for each of the k distinct motifs, using the chord assigned to that class of motifs, using one or more of the methods outlined above. For example, if the chord to motif assignments are {Motif_1->Chord_1, . . . . Motif_p->Chord_q, . . . } then Motif_p would use the notes available in the Chord_q, etc. Note that the motifs can be generated with any of the above methods singly or in combination, and could be constructed as:
         i. a sequence of {note, type, volume} triples or
         ii. a sequence of {note, type} pairs and a sequence of volumes, or
         iii. a sequence of {note, volume} pairs and a sequence of types, or
         iv. a sequence of {type, volume} pairs and a sequence of notes, or
         v. a sequence of notes, a sequence of types, and a sequence of volumes.
      e. Convert the note types into equivalent note durations given the time signature (a.k.a. meter) and tempo (a.k.a. beats per minute or BPM), using the method outlined in FIG. 5.
      f. Assemble the k-distinct motifs into the sequence of N bars implied by the motif structure, M, where all motif labels in the same equivalence family may be assigned the same motif music.
      g. Accumulate the bar durations to shift the start time of the motif for each bar to the correct time.
      h. Concatenate the bars and return the resulting music.
   3. Possible Variations Across Implementations:
      a. The Provision of Mood Presets: In some implementations, there exists a data structure that associates, for each allowed mood label, a corresponding (restricted) set of:
         i. allowed time signatures and tempos; or
         ii. allowed time signatures, tempos, and pitch range; or
         iii. allowed time signatures, tempos, and instruments; or
         iv. allowed time signatures, tempos, and rhythm patterns; or
         v. allowed time signatures, tempos, and genres; or
         vi. allowed time signatures, tempos, and any combination of pitch range, instrument, rhythm pattern, genre
         vii. An example of such an association is as follows:

```
Mood[“Deep-Depression”] −>
  {
    TimeSignature[“4/4”]
    Tempo[55 BPM - 90 BPM],
    Instruments[{“BaritoneSax”, “Bassoon”, ..., “Violin”, “Voice”},
    TypicalPitchRange[{“C2”, “B4”}]
  }
```

b. The Provision of Sentiment Presets: In some implementations, there exists a data structure that associates, for each allowed mood label, a corresponding sentiment label, from a set such as {“Negative”, “Positive”}, or a more discriminating set such as {“Strongly Negative”, “Negative”, “Weakly Negative”, “Neutral”, “Weakly Positive”, “Positive”, “Strongly Positive”} etc., and there exists a data structure that associates, for each allowed sentiment label, a corresponding set of:
   i. allowed time signatures and tempos; or
   ii. allowed time signatures, tempos, and pitch range; or
   iii. allowed time signatures, tempos, and instruments; or
   iv. allowed time signatures, tempos, and rhythm patterns; or
   v. allowed time signatures, tempos, and genres; or
   vi. allowed time signatures, tempos, and any combination of pitch range, instrument, rhythm pattern, genre
   vii. An advantage of such implementations is that there are typically considerably more mood labels than sentiment labels; and that whereas sentiment is fairly well correlated with tempo, and may be inferred automatically using standard machine learning techniques, without the intermediate sentiment label, the association of time signature and tempo with each mood label must be entered manually, which is a highly time consuming and laborious process.
   viii. An example of such an association is as follows:

```
Sentiment[“Strongly Negative”] −>
  {
    TimeSignature[“4/4”]
    Tempo[55 BPM - 90 BPM],
    Instruments[{“Oboe”, “Bassoon”, ..., “Violin”, “Voice”},
    TypicalPitchRange[{“A1”, “F4”}]
  }
```

ix. Then if Sentiment [Mood [“Deep-Depression”]=Sentiment [“Strongly Negative”], the mood presents for Mood [“Deep-Depression”] may use the mood presets for Sentiment [“Strongly Negative”].
c. The Provision of a Target Composition Duration and the Consequential Necessary Adjustment of Tempo to Fit the Motif Structure: In some implementations, a duration for the musical piece overall may be specified, i.e., a time interval over which the motif structure is to be played. In this case, any provided tempo can only be regarded as a suggestion, and instead an adjusted tempo may be computed as close to the target tempo as possible, while ensuring that the given duration can be partitioned into an integer number, N, of complete musical measures (a.k.a. bars);
d. Specifying a Key/Scale in lieu of a Mood: In some implementations, rather than providing a target mood, a target key and scale may be provided. Then rather than generating a mood-specific chord progression, a key/scale-specific chord progression may be generated. In the latter, techniques for making smooth chord progressions by choosing specific inversions of chords to minimize note movement across the progression may be employed.
e. Specifying a Roman Chord Progression in lieu of a Mood: In some implementations, rather than providing a target mood, a desired key and target Roman chord progression may be provided, such as the following:
   i. Major Roman Progressions: {“I-I-IV-V”, “I-ii-V”, “I-biii-IV-biii”, “I-iii-IV-V”, “I-iii-vi-IV”, “I-IV-I-V”, “I-IV-ii-V”, “I-IV-V”, “I-IV-V-IV”, “I-vi-V”, “I-bVII-IV”, “ii-V-I”, “IV-V-vi-iii”, “V-I-IV”, “V-IV-I”, “vi-IV-I-V”, “vi-V-IV-iii”, “vi-V-IV-V”, “I-IV-V”, “I-IV-V-IV”, “I-IV-V-V”, “I-IV-viio-iii-vi-ii-V-I”, “I-IV-bviio-IV”, “I-IV-bvii-IV”, “I-V-IV-V”, “I-V-vi-IV”, “I-vi-V”}
   ii. Minor Roman Progressions: {“i-iv-v-i”, “i-iv7-v7-i”, “i-iv-VII”, “i-VI-III-VII”, “i-vi7-iv7-v7”, “i-VI-VII”, “i-VII-VI-VII”, “iio-v-i”, “VI-VII-i-i”, “vi6-ii-v6-1”, “i-iv-i”, “i-iv-v”, “i-iv-v-i”, “i-iv7-v7-i”, “i-iv-VII”, “i-VI-III-VII”, “i-bVII-bVI-V”, “i-VI-III-VII”, “i-iv-i-VI-V7-i”, “i-iv-v”, “i-VI-III-iv”, “iio-v-i”, “i-iio-v-i”, “i-VII-VI”, “i-VII-VI-v”, “i-iv-Ill-VI”, “i-iv-VI-v”, “VI-VII-i”, “i-iv-III-VI”, “VI-VII-i”, “i-iv-VI-v”, “i-VI-III-VII”, “i-VI-III-iv”, “i-iv-i-VI-V7-i”, “vi-V-IV-V”, “IV-16-ii”, “I-V6-vi-V”, “I-V-vi-iii-IV”, “i-III-VII-VI”, “i-V-vi-IV”, “i-VII-III-VI”, “I-vi-IV-V”, “I-IV-vi-V”, “I-V-vi-IV”, “I-V-vi-IV”, “I-IV-V”, “I-IV-V-IV”, “ii-V-I”, “iimin7-Vdom7-1maj7”, “I-vi-IV-V”, “I-V-vi-iii-IV-I-IV-V”, “I-bVII-I”, “I-vi-IV-V”, “I-V-vi-IV”, “I-IV-bVII-IV”, “ii-bII7-I”, “ii-bIII+-I”, “viio/V-V-I”}.
   iii. Here a lowercase Roman numeral means a minor chord, except if it is ended with a “o” in which case it is a diminished chord. An uppercase Roman numeral is a major chord. A “b” before the Roman numeral means a flatted chord. A “+” means an augmented chord. A 6 or 7 means a sixth or seventh of the indicated chord.
Then, rather than generating a mood-specific chord progression, a realization of the chosen Roman chord progression may be generated in the chosen key. However, the Roman progression may be used in the same way as the mood-specific progression, wherein all motifs in the same equivalence class may be associated with the same Roman chord. It might, in this case be necessary to concatenate repetitions of the Roman chord progression to make a longer progression, of the length of the progression is less than the number of distinct motifs, k.
f. Specifying a Bespoke Chord Progression in lieu of a Mood: In some implementations, rather than providing a target mood, a bespoke chord progression may be provided, such as the following: {“G #4add9”, “Db4add9|1”, “B4add9|3”, “Gb4add9|2”, “Db4add9|1”, “A4add9|3”, “F4add9|3”, “A4add9|3”, “Gb4add9|3”, “A4add9|3”, “E4add9”, “A4add9|1”} where “ . . . |n” means the chord in the nth inversion.
g. Specifying a Multiplicity of Modulating Key/Scales: In some implementations, rather generating a mood-specific chord progression, a chord progression may be generated for a first key/scale for a first portion of the motif structure, and a chord progression may be generated for a second key/scale for a second portion of a motif structure. The boundary being determined, for example, as taught in Segmentation Patent.
h. Augmentation of “Ambient Moods” with One or More “Motif Mood(s)”: In some implementations, a motif generated in the given ambient mood may be overlaid with a motif having a more specific motif mood. For example, the ambient mood might be “Happy”, and the motif mood might be “Home” (for example). The creation of such motif moods may be accomplished by generating a note sequence that uses prescribed intervals, as detailed in section entitled “4. Note Motifs Generated from a Finite Set of Motif Mood Labels”.
i. Augmentation of “Ambient Moods” with a Prescribed “Genre”: Whereas the ambient mood generally determines the time signature, tempo, instrumentation, and typical note range, a supplied “genre” label can influence these choices. A genre label may also select a certain style of “rhythm pattern” to be played under the motif structure, but it can also cause a modification of the instrumentation, and tempo too. A “rhythm pattern” associates a genre label with a time signature, a typical tempo range, a set of beat indices at which percussion instrument strikes of specific percussion instruments will occur, together with alternate forms for different bars (measures). Some examples are shown below. Notice that the determination of the actual time of percussion instrument strikes is determined from a computation based on the time signature, the tempo, which allows computation of beat times, and hence the inferred strike times. This allows one rhythm pattern to be adapted to different tempos:
   i. Exemplary Rhythm Pattern For Genre (Rock):
   1. “Rock”, (the genre label)
   2. “4/4”, (time signature)
   3. {64, 109}, (typical tempo range)
   4. “Measure A”->
   a. “Accent”-> {1, 3, 5, 7, 9, 11, 13, 15}, (beats on which hits occur)
   b. “HiHatClosed”-> {1, 2, 3, 4, 5, 6, 7, 8, 9, 10, 11, 12, 13, 14, 15},
   c. “HiHatOpen”-> {16},
   d. “Snare”-> {5, 13}, (percussion instrument is indicated)
   e. “BassDrum”-> {1, 3, 6, 9, 16},
   5. “Measure B”->
   a. “HiHatClosed”-> {1, 2, 3, 4, 5, 6, 7, 9, 10, 11, 12, 13, 14, 15},
   b. “HiHatOpen”-> {8, 16},
   c. “Snare”-> {5, 13, 15},
   d. “BassDrum”-> {1, 3, 6, 9, 16}},
   e. “Break”-> {“CrashCymbal”-> {13, 15},
   f. “MidTom”-> {5, 6, 7, 8},
   g. “Snare”-> {1, 2, 3, 4},
   h. “LowTom”-> {9, 10, 11, 12},
   i. “BassDrum”-> {1, 3, 6, 9, 11, 13, 15}
   ii. Exemplary Rhythm Pattern for Genre (Samba):
   1. “Samba”, (genre label)
   2. “4/4”, (time signature)
   3. {80, 130}, (typical tempo range)
   4. “Measure A”->
   a. “Accent”-> {1, 5, 9, 13}, (beats on which hits occur)
   b. “HiHatClosed”-> {1, 2, 3, 4, 5, 6, 7, 8, 9, 10, 11, 12, 13, 14, 15, 16},
   c. “Snare”-> {5, 13}, (percussion instrument is indicated)
   d. “BassDrum”-> {1, 4, 5, 8, 9, 12, 13, 16}},
   5. “Measure B”->
   a. “Accent”-> {8, 12},
   b. “HiHatClosed”-> {2, 4, 7, 9, 12, 15},
   c. “Snare”-> {1, 3, 5, 6, 8, 10, 11, 13, 14, 16},
   d. “BassDrum”-> {1, 4, 5, 8, 9, 12, 13, 16}},
   e. “Break”-> {“HiHatClosed”-> {1, 2, 7, 8, 11, 13},
   f. “HiHatOpen”-> {16},
   g. “HighTom”-> {3, 5},
   h. “MidTom”-> {9},
   i. “Snare”-> {3, 5, 9, 12, 15},
   j. “LowTom”-> {12, 15},
   k. “BassDrum”-> {1, 4, 5, 8, 9, 12, 13, 16}}}],
      Generating Multi-Track Music in Targeted Ambient Mood(S), and/or Desired Key/Scales, and/or Genres, Using a Motif Structure

In some implementations, generalizing the present systems, methods, and computer program products to multi-track music has the complication that the motif structure may imply two motifs are equivalent in different bars, and yet the chords to which those motifs are assigned might differ. The various implementations described herein include at least two exemplary methods for handling such situations: the first imposes the same chord assignment on all motifs in the same column, and then adjusts motifs to comply with their local chord assignment; the second method sets up a system of constraints that dictate which motifs should be the same (as dictated by the motif structure), and which motifs should be consonant (namely all those in the same column). The system may then be solved to yield a maximal satisfying solution of all the constraints, to determine a chord assignment to each motif against which it is locally tuned.
a. Creating Multi-Track Motifs in a Targeted Ambient Mood Using a Motif Structure and Common Chord Assignment to Distinct “Column Motifs”
   1. Given:
      a. The goal of generating multi-track music having a desired ambient mood
      b. a target ambient mood
      c. a motif structure, having T tracks, represented as an array
         M={Motif_11, Motif_12, . . . , Motif_1N}, {Motif_21, Motif_22, . . . , Motif_2N},
         {Motif_T1, Motif_T2, . . . , Motif_TN},
      which specifies (a) the number of bars (N) and (b) the number tracks (T in this case), and (c) which bar/track coordinates are deemed the “same” motif, i.e., which motifs Motif_ij and Motif_mn are deemed to be the “same”.
      d. (optionally) a time signature, a tempo, and an instrument. Alternatively, the time signature, and/or the tempo, and/or the instrument might be computed from the mood (as explained previously).
   2. Method:
      a. Compute the number of distinct “column motifs”, k, in the motif structure, i.e., the minimal subset of the columns (of motifs), each a vertical slice through the motif structure, from the motif structure, M, such that no two column motifs in the subset are the same. Note that this step determines the parameter, k.
      b. Generate a mood-specific chord progression, Chord_1, Chord_2, . . . , Chord_k of length k chords for the given mood (e.g., per Mood Sequence Patent).
      j. Assign motif placeholders to chords: Starting from the earliest non-empty column motif (e.g., suppose this is the first column of the motif structure), assign this first column motif, and all column motifs equivalent to this first column motif, to Chord_1 of the length k chord progression. Then move on to the next non-empty column motif in temporal order that is not yet assigned a chord. Assign this temporally next “not-yet-assigned” column motif, and all column motifs equivalent to this next column motif, the next chord Chord_2. Repeat this process of assigning the next unassigned column motif (and all those equivalent to it) to the next chord in the chord progression, until all column motifs have been assigned chords, and all k chords have been used. The result may then include the sequence of assignments {Motif_11->Chord_1, Motif_21->Chord_1, Motif_31->Chord_1, Motif_T1->Chord_1, . . . . Motif_mn->Chord_q, . . . } etc. For example, the same chord may be assigned to all motifs within the same bar.
      c. Generate a motif for each of the k distinct motifs, using the chord assigned to that class of motifs, using one or more of the methods outlined above. For example, if the chord to motif assignments are {Motif_11->Chord_1, Motif_21->Chord_1, Motif_31->Chord_1, . . . . Motif_T1->Chord_1, . . . . Motif_mn->Chord_q, . . . } then Motif_mn would use the notes available in the Chord_q, etc. Note that in this method, if Motif_pq is equivalent to Motif_rs, and yet Motif_pq is assigned Chord_i, whereas Motif_rs is assigned a different chord, Chord_j (where Chord_i!=Chord_j), the note type and note volume sequence may be the same for Motif_pq and Motif_rs, a note sequence for Motif_pq may be generated from the notes of Chord_i, and the note sequence for Motif_rs may follow the same sequence of RELATIVE chord notes but using the notes of Chord_j instead of Chord_i. That is, if the note motif for Motif_pq uses (for example) the sequence of {the first chord note of Chord_i, then the third chord note of Chord_i, then the fourth chord note of Chord_i}, then the note motif for Motif_rs would use the first chord note of Chord_j, then the third chord note of Chord_j, then the fourth chord note of Chord_j, etc. If the number of chord notes in Chord_i exceeds the number in Chord_j, an extended chord of Chord_j may be used. For example, if Chord_i contained 4 notes (e.g., seventh chord, e.g., Cmaj7), but Chord_j contained 3 notes (e.g., Gmaj), the extended chord Gmaj7 may be used instead of Gmaj for Chord_j. Note that the motifs can be generated with any of the above methods singly or in combination, and could be constructed as:
         i. a sequence of {note, type, volume} triples or
         ii. a sequence of {note, type} pairs and a sequence of volumes, or
         iii. a sequence of {note, volume} pairs and a sequence of types, or
         iv. a sequence of {type, volume} pairs and a sequence of notes, or
         v. a sequence of notes, a sequence of types, and a sequence of volumes.
      d. Convert the note types into equivalent note durations given the time signature (a.k.a. meter) and tempo (a.k.a. beats per minute or BPM), using the method outlined in FIG. 5.
      e. Assemble the k-distinct motifs into the sequence of N bars implied by the motif structure, M, where all motif labels in the same equivalence family are assigned the same motif music.
      f. Accumulate the bar durations to shift the start time of the motif for each bar to the correct time.
      g. Concatenate the bars and return the resulting music.
3. Possible Variations Across Implementations include the same variations as those described in the single-track method. For brevity these are summarized by their headings here. The extended descriptions of these variations are substantially similar to those for the single-track method given above:
   a. The Provision of Mood Presets
   b. The Provision of Sentiment Presets
   c. The Provision of a Target Composition Duration and the Consequential Necessary Adjustment of Tempo to Fit the Motif Structure
   d. Specifying a Key/Scale in lieu of a Mood
   e. Specifying a Roman Chord Progression in lieu of a Mood
   f. Specifying a Bespoke Chord Progression in lieu of a Mood
   g. Specifying a Multiplicity of Modulating Key/Scales
   h. Augmentation of “Ambient Mood” with One or More “Motif Mood(s)”
   i. Augmentation of “Ambient Mood” with a Prescribed “Genre”
b. Creating Multi-Track Motifs in a Targeted Ambient Mood Using a Motif Structure and Common Chord Assignment Based on Maximizing the Satisfiability a Systems of Constraints The second exemplary method for assigning chords to motifs sets up a system of constraints that dictate which motifs should be the same (as dictated by the motif structure), and which motifs should be consonant (namely all those in the same column of the motif structure). The system may then be solved to yield a maximal satisfying solution of all the constraints, to determine a chord assignment to each motif against which it is locally tuned.
   1. Given:
      a. The goal of generating multi-track music having a desired ambient mood
      b. a target ambient mood
      c. a motif structure, having T tracks, represented as an array
         a. M={Motif_11, Motif_12, . . . , Motif_1N},
         i. {Motif_21, Motif_22, . . . , Motif_2N},
         ii. . . .
         iii. {Motif_T1, Motif_T2, . . . , Motif_TN},
         ii. which specifies (a) the number of bars (N) and (b) the number tracks (T in this case), and (c) which bar/track coordinates are deemed the “same” motif, i.e., which motifs Motif_ij and Motif_mn are deemed to be the “same”.
      d. (optionally) a time signature, a tempo, and an instrument. Alternatively, the time signature, and/or the tempo, and/or the instrument might be computed from the mood (as explained in SECTION 4).
   2. Method:
      a. Create the constraints that every chord assignment, must be a chord of the given ambient mood: for all motifs in the motif structure
         i. ChordAssignment(motif)=OneOf(chord1, chord2, chord3, . . . , chordk) where {chord1, chord2, chord3, . . . , chordk} are the chords associated with the given ambient motif mood.
      b. Create the constraints that certain chord assignments must match: for all pairs of motifs in the motif structure create the constraint . . .
         i. ChordAssignment(Motif_pq)=ChordAssignment(Motif_rs) if and only if Motif_pq and Motif_rs are the same in the motif structure.
      c. Create the constraints that all chord assignments to motifs that lie in the same bar should be predominantly consonant: for all pairs of motifs in bar j (corresponding to one vertical column in the motif structure), create constraint:
         i. IsConsonantQ(ChordAssignment(Motif_pj), ChordAssignment(Motif_qj)
         ii. where IsConsonantQ(chord1, chord2) is TRUE if the note intervals between the notes of chord1, and the notes of chord2, are predominantly consonant, i.e., are categorized as “StronglyConsonant”, “Consonant”), and FALSE otherwise.
      d. Require that all motifs have some chord assignment
      e. Find a maximally satisfying solution to the aforementioned constraints: for example, a greedy algorithm may be used to find a set of assignments of chords to motifs that satisfy the largest feasible number of constraints. Call this solution S={ChordAssignment(Motif_pq)=chordi, . . . } etc
      f. Generate a motif for each distinct motifs, using the chord assigned to each motif, S, use one or more of the methods outlined above to generate a motif. Note that the motifs can be generated with any of the above methods singly or in combination, and could be constructed as:
         i. a sequence of {note, type, volume} triples or
         ii. a sequence of {note, type} pairs and a sequence of volumes, or
         iii. a sequence of {note, volume} pairs and a sequence of types, or
         iv. a sequence of {type, volume} pairs and a sequence of notes, or
         v. a sequence of notes, a sequence of types, and a sequence of volumes.
      g. Convert the note types into equivalent note durations given the time signature (a.k.a. meter) and tempo (a.k.a. beats per minute or BPM), using the method outlined in FIG. 5.
      h. Assemble the distinct motifs into the sequence of N bars implied by the motif structure, M, where all motif labels in the same equivalence family are assigned the same motif music.
      i. Accumulate the bar durations to shift the start time of the motif for each bar to the correct time.
      j. Concatenate the bars and return the resulting music.
3. Possible Variations Across Implementations include the same variations as those described in the single-track method. For brevity these are summarized by their headings here. The extended descriptions of these variations are substantially similar to those for the single-track method given above:
   a. The Provision of Mood Presets (as in Section 5(a)(3)(a))
   b. The Provision of Sentiment Presets (as in Section 5(a)(3)(b))
   c. The Provision of a Target Composition Duration and the Consequential Necessary Adjustment of Tempo to Fit the Motif Structure (as in Section 5(a)(3)(c))
   d. Specifying a Key/Scale in lieu of a Mood (as in Section 5(a)(3)(d))
   e. Specifying a Roman Chord Progression in lieu of a Mood (as in Section 5(a)(3)(e))
   f. Specifying a Bespoke Chord Progression in lieu of a Mood (as in Section 5(a)(3)(f))
   g. Specifying a Multiplicity of Modulating Key/Scales (as in Section 5(a)(3)(g))
   h. Augmentation of “Ambient Mood” with One or More “Motif Mood(s)” (as in Section 5(a)(3)(h))
   i. Augmentation of “Ambient Mood” with a Prescribed “Genre” (as in Section 5(a)(3)(i))

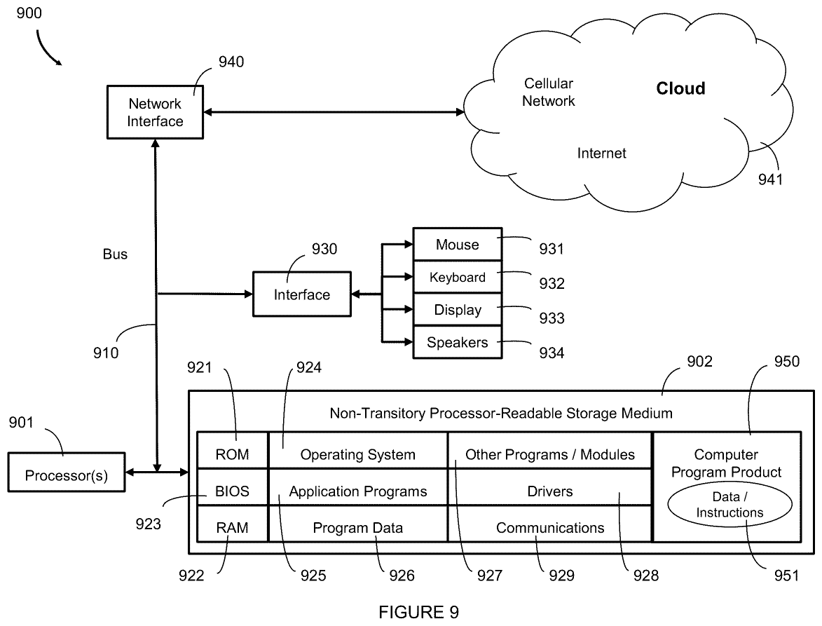

The various implementations described herein often make reference to “computer-based,” “computer-implemented,” “at least one processor,” “a non-transitory processor-readable storage medium,” and similar computer-oriented terms. A person of skill in the art will appreciate that the present systems, computer program products, and methods may be implemented using or in association with a wide range of different hardware configurations, including localized hardware configurations (e.g., a desktop computer, laptop, smartphone, or similar) and/or distributed hardware configurations that employ hardware resources located remotely relative to one another and communicatively coupled through a network, such as a cellular network or the internet. For the purpose of illustration, exemplary computer systems suitable for implementing the present systems, computer program products, and methods are provided in FIG. 9.

FIG. 9 is an illustrative diagram of an exemplary computer-based musical composition system 900 suitable at a high level for performing the various computer-implemented methods described in the present systems, computer program products, and methods. Although not required, some portion of the implementations are described herein in the general context of data, processor-executable instructions or logic, such as program application modules, objects, or macros executed by one or more processors. Those skilled in the art will appreciate that the described implementations, as well as other implementations, can be practiced with various processor-based system configurations, including handheld computer program products, such as smartphones and tablet computers, multiprocessor systems, microprocessor-based or programmable consumer electronics, personal computers (“PCs”), network PCs, minicomputers, mainframe computers, and the like.

Computer-based musical composition system 900 includes at least one processor 901, a non-transitory processor-readable storage medium or “system memory” 902, and a system bus 910 that communicatively couples various system components including the system memory 902 to the processor(s) 901. Computer-based musical composition system 900 is at times referred to in the singular herein, but this is not intended to limit the implementations to a single system, since in certain implementations there will be more than one system or other networked computing device(s) involved. Non-limiting examples of commercially available processors include, but are not limited to: Core microprocessors from Intel Corporation, U.S.A., PowerPC microprocessor from IBM, ARM processors from a variety of manufacturers, Sparc microprocessors from Sun Microsystems, Inc., PA-RISC series microprocessors from Hewlett-Packard Company, and 68xxx series microprocessors from Motorola Corporation.

The processor(s) 901 of computer-based musical composition system 900 may be any logic processing unit, such as one or more central processing units (CPUs), microprocessors, digital signal processors (DSPs), application-specific integrated circuits (ASICs), field programmable gate arrays (FPGAs), and/or the like. Unless described otherwise, the construction and operation of the various blocks shown in FIG. 9 may be presumed to be of conventional design. As a result, such blocks need not be described in further detail herein as they will be understood by those skilled in the relevant art.

The system bus 910 in the computer-based musical composition system 900 may employ any known bus structures or architectures, including a memory bus with memory controller, a peripheral bus, and/or a local bus. The system memory 902 includes read-only memory (“ROM”) 921 and random access memory (“RAM”) 922. A basic input/output system (“BIOS”) 923, which may or may not form part of the ROM 921, may contain basic routines that help transfer information between elements within computer-based musical composition system 900, such as during start-up. Some implementations may employ separate buses for data, instructions and power.

Computer-based musical composition system 900 (e.g., system memory 902 thereof) may include one or more solid state memories, for instance, a Flash memory or solid state drive (SSD), which provides nonvolatile storage of processor-executable instructions, data structures, program modules and other data for computer-based musical composition system 900. Although not illustrated in FIG. 9, computer-based musical composition system 900 may, in alternative implementations, employ other non-transitory computer- or processor-readable storage media, for example, a hard disk drive, an optical disk drive, or a memory card media drive.

Program modules in computer-based musical composition system 900 may be stored in system memory 902, such as an operating system 924, one or more application programs 925, program data 926, other programs or modules 927, and drivers 928.

The system memory 902 in computer-based musical composition system 900 may also include one or more communications program(s) 929, for example, a server and/or a Web client or browser for permitting computer-based musical composition system 900 to access and exchange data with other systems such as user computing systems, Web sites on the Internet, corporate intranets, or other networks as described below. The communications program(s) 929 in the depicted implementation may be markup language based, such as Hypertext Markup Language (HTML), Extensible Markup Language (XML) or Wireless Markup Language (WML), and may operate with markup languages that use syntactically delimited characters added to the data of a document to represent the structure of the document. A number of servers and/or Web clients or browsers are commercially available such as those from Google (Chrome), Mozilla (Firefox), Apple (Safari), and Microsoft (Internet Explorer).

While shown in FIG. 9 as being stored locally in system memory 902, operating system 924, application programs 925, program data 926, other programs/modules 927, drivers 928, and communication program(s) 929 may be stored and accessed remotely through a communication network or stored on any other of a large variety of non-transitory processor-readable media (e.g., hard disk drive, optical disk drive, SSD and/or flash memory).

Computer-based musical composition system 900 may include one or more interface(s) to enable and provide interactions with a user, peripheral device(s), and/or one or more additional processor-based computer system(s). As an example, computer-based musical composition system 900 includes interface 930 to enable and provide interactions with a user of computer-based musical composition system 900. A user of computer-based musical composition system 900 may enter commands, instructions, data, and/or information via, for example, input computer program products such as computer mouse 931 and keyboard 932. Other input computer program products may include a microphone, joystick, touch screen, game pad, tablet, scanner, biometric scanning device, wearable input device, and the like. These and other input computer program products (i.e., “I/O computer program products”) are communicatively coupled to processor(s) 901 through interface 930, which may include one or more universal serial bus (“USB”) interface(s) that communicatively couples user input to the system bus 910, although other interfaces such as a parallel port, a game port or a wireless interface or a serial port may be used. A user of computer-based musical composition system 900 may also receive information output by computer-based musical composition system 900 through interface 930, such as visual information displayed by a display 933 and/or audio information output by one or more speaker(s) 934. Monitor 933 may, in some implementations, include a touch screen.

As another example of an interface, computer-based musical composition system 900 includes network interface 940 to enable computer-based musical composition system 900 to operate in a networked environment using one or more of the logical connections to communicate with one or more remote computers, servers and/or computer program products (collectively, the “Cloud” 941) via one or more communications channels. These logical connections may facilitate any known method of permitting computers to communicate, such as through one or more LANs and/or WANs, such as the Internet, and/or cellular communications networks. Such networking environments are well known in wired and wireless enterprise-wide computer networks, intranets, extranets, the Internet, and other types of communication networks including telecommunications networks, cellular networks, paging networks, and other mobile networks.

When used in a networking environment, network interface 940 may include one or more wired or wireless communications interfaces, such as network interface controllers, cellular radios, WI-FI radios, and/or Bluetooth radios for establishing communications with the Cloud 941, for instance, the Internet or a cellular network.

In a networked environment, program modules, application programs or data, or portions thereof, can be stored in a server computing system (not shown). Those skilled in the relevant art will recognize that the network connections shown in FIG. 9 are only some examples of ways of establishing communications between computers, and other connections may be used, including wirelessly.

For convenience, processor(s) 901, system memory 902, interface 930, and network interface 940 are illustrated as communicatively coupled to each other via the system bus 910, thereby providing connectivity between the above-described components. In alternative implementations, the above-described components may be communicatively coupled in a different manner than illustrated in FIG. 9. For example, one or more of the above-described components may be directly coupled to other components, or may be coupled to each other via intermediary components (not shown). In some implementations, system bus 910 may be omitted with the components all coupled directly to each other using suitable connections.

In accordance with the present systems, computer program products, and methods, computer-based musical composition system 900 may be used to implement or in association with any or all of the methods and/or acts described herein, and/or to encode, manipulate, vary, and/or generate any or all of the musical compositions described herein. Where the descriptions of the acts or methods herein make reference to an act being performed by at least one processor or more generally by a computer-based musical composition system, such act may be performed by processor(s) 901 and/or system memory 902 of computer system 900.

Computer system 900 is an illustrative example of a system for performing all or portions of the various methods described herein, the system comprising at least one processor 901, at least one non-transitory processor-readable storage medium 902 communicatively coupled to the at least one processor 901 (e.g., by system bus 910), and the various other hardware and software components illustrated in FIG. 9 (e.g., operating system 924, mouse 931, etc.). In particular, in order to enable system 900 to implement the present systems, computer program products, and methods, system memory 902 stores a computer program product 950 comprising processor-executable instructions and/or data 951 that, when executed by processor(s) 901, cause processor(s) 901 to perform the various acts of methods that are performed by a computer-based musical composition system.

Throughout this specification and the appended claims, the term “computer program product” is used to refer to a package, combination, or collection of software comprising processor-executable instructions and/or data that may be accessed by (e.g., through a network such as cloud 941) or distributed to and installed on (e.g., stored in a local non-transitory processor-readable storage medium such as system memory 902) a computer system (e.g., computer system 900) in order to enable certain functionality (e.g., application(s), program(s), and/or module(s)) to be executed, performed, or carried out by the computer system.

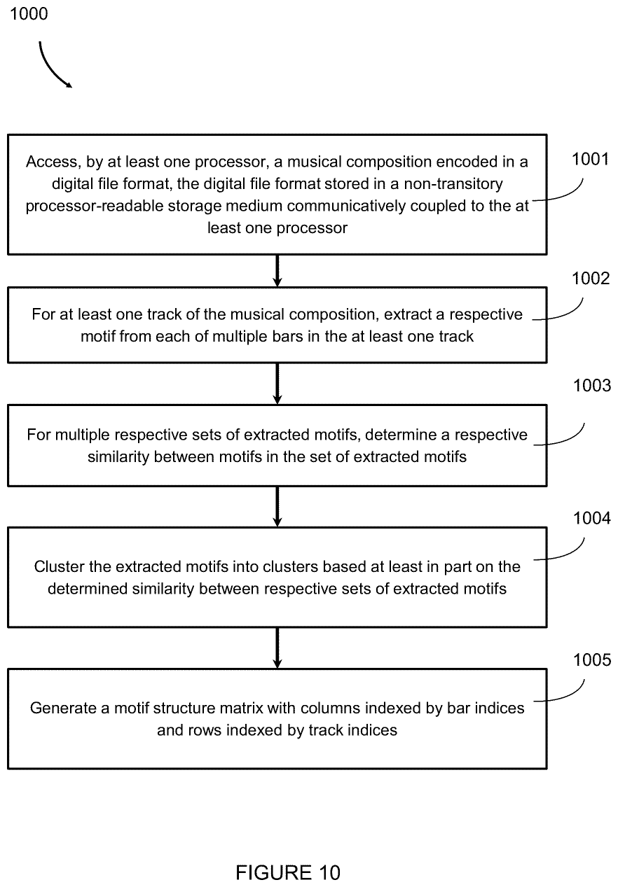

FIG. 10 is a flow diagram of a computer-implemented method 1000 of generating a motif structure in accordance with the present systems, computer program products, and methods. Method 1000 illustrates at least some of the exemplary methods described above, and in some implementations may be deployed by a computer program product. In general, throughout this specification and the appended claims, a computer-implemented method is a method in which the various acts are performed by one or more processor-based computer system(s), such as a computer-based musical composition system. For example, certain acts of a computer-implemented method may be performed by at least one processor communicatively coupled to at least one non-transitory processor-readable storage medium or memory (hereinafter referred to as a non-transitory processor-readable storage medium) and, in some implementations, certain acts of a computer-implemented method may be performed by peripheral components of the computer system that are communicatively coupled to the at least one processor, such as interface computer program products, sensors, communications and networking hardware, and so on. The non-transitory processor-readable storage medium may store data and/or processor-executable instructions (e.g., a computer program product) that, when executed by the at least one processor, cause the computer system to perform the method and/or cause the at least one processor to perform those acts of the method that are performed by the at least one processor. FIG. 9 and the written descriptions thereof provide illustrative examples of computer systems that are suitable to perform the computer-implemented methods described herein.

Returning to FIG. 10, method 1000 includes five acts 1001, 1002, 1003, 1004, and 1005, though those of skill in the art will appreciate that in alternative implementations certain acts may be omitted and/or additional acts may be added. Those of skill in the art will also appreciate that the illustrated order of the acts is shown for exemplary purposes only and may change in alternative implementations.

At 1001, at least one processor of a computer-based musical composition system accesses a musical composition encoded in a digital file format, the digital file format stored in a non-transitory processor-readable storage medium communicatively coupled to the at least one processor. In some implementations, the digital file format may be a MIDI file format. In such implementations, method 1000 may also include, converting the digital file format into an alternative file format in which each track of the musical composition is designated by a respective object, such as the .hum file format described in Hum Patent.

At 1002, for at least one track of the musical composition, a respective motif is extracted from each of multiple bars in the at least one track. In some implementations, a respective motif may be extracted from each bar in the track.

At 1003, for multiple respective sets of extracted motifs, a respective similarity is determined between motifs in the set of extracted motifs. In implementations in which a respective motif is extracted from each bar in each track, a respective similarity may be determined between each extracted motif in a given bar and a given track and each other extracted motif in each other bar in each other track.

At 1004, the extracted motifs are grouped, categorized, or “clustered” into clusters based at least in part on the determined similarity between respective sets of extracted motifs.

At 1005, a motif structure matrix is generated with columns indexed by bar indices and rows indexed by track indices. The motif structure matrix may be returned and stored in the non-transitory processor-readable storage medium of the computer-based musical composition system. The motif structure matrix may constitute data in a computer program product as described herein, and may be leveraged in other methods and computer program products, for example as the motif structure from which a musical composition (single track or multi-track) may be generated as described herein.

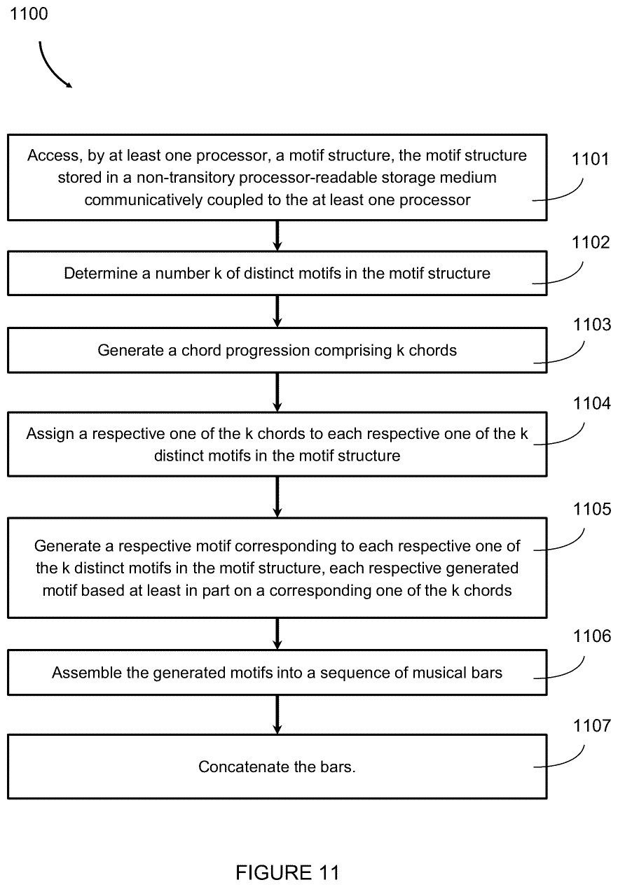

FIG. 11 is a flow diagram of a computer-implemented method 1100 of generating a musical composition (e.g., based on a given motif structure) in accordance with the present systems, computer program products, and methods. Method 1100 includes seven acts 1101, 1102, 1103, 1104, 1105, 1106, and 1007 though those of skill in the art will appreciate that in alternative implementations certain acts may be omitted and/or additional acts may be added. Those of skill in the art will also appreciate that the illustrated order of the acts is shown for exemplary purposes only and may change in alternative implementations.

At 1101, at least one processor of the computer-based musical composition system accesses a motif structure, the motif structure stored in a non-transitory processor-readable storage medium communicatively coupled to the at least one processor. The motif structure may include a motif structure matrix such as that generated at 1005 of method 1000.

At 1102, a number k of distinct motifs is determined in the motif structure. In this context, the specific compositions (e.g., notes, durations, and/or volumes) of the k distinct motifs may not be known. The motif structure may identify the positions/placements of motifs and identify whether the motifs are the same or distinct (and, in some implementations, the degree of distinctiveness), all without defining the composition of any particular motif.

At 1103, a chord progression comprising k chords is defined (k being the number of distinct motifs determined at 1102 above).

At 1104, a respective one of the k chords is assigned to each respective one of the k distinct motifs in the motif structure, such that each distinct motif has assigned to it a respective chord. In some implementations the k chords may all be distinct, whereas in other implementations not all of the k chords are necessarily distinct (i.e., at least two chords in the set of k chords may be separate instances of the same chord).

At 1105, a respective motif corresponding to each respective one of the k distinct motifs in the motif structure is generated, each respective generated motif based at least in part on a corresponding one of the k chords. In other words, at 1102 the placements/positions (i.e., existence) of distinct motifs are extracted and at 1105 the composition of each extracted motif in the k distinct extracted motifs is established. That is, the notes, durations, and volumes corresponding to each motif may be defined/generated, where each generated motif uses at least one note (or is limited to use only notes) from the chord that has been assigned to that particular motif at 1104.

At 1106, motifs generated at 1105 are assembled into a sequence of musical bars (e.g., based on the positions of the corresponding distinct motifs in the motif structure). At 1107, the bars from 1106 are concatenated to form a sequence; i.e., a musical composition.

Throughout this specification and the appended claims, reference is often made to musical compositions being “automatically” generated/composed by computer-based algorithms, software, and/or artificial intelligence (A1) techniques. A person of skill in the art will appreciate that a wide range of algorithms and techniques may be employed in computer-generated music, including without limitation: algorithms based on mathematical models (e.g., stochastic processes), algorithms that characterize music as a language with a distinct grammar set and construct compositions within the corresponding grammar rules, algorithms that employ translational models to map a collection of non-musical data into a musical composition, evolutionary methods of musical composition based on genetic algorithms, and/or machine learning-based (or A1-based) algorithms that analyze prior compositions to extract patterns and rules and then apply those patterns and rules in new compositions. These and other algorithms may be advantageously adapted to exploit the features and techniques enabled by the digital representations of music described herein.

Throughout this specification and the appended claims the term “communicative” as in “communicative coupling” and in variants such as “communicatively coupled,” is generally used to refer to any engineered arrangement for transferring and/or exchanging information. For example, a communicative coupling may be achieved through a variety of different media and/or forms of communicative pathways, including without limitation: electrically conductive pathways (e.g., electrically conductive wires, electrically conductive traces), magnetic pathways (e.g., magnetic media), wireless signal transfer (e.g., radio frequency antennae), and/or optical pathways (e.g., optical fiber). Exemplary communicative couplings include, but are not limited to: electrical couplings, magnetic couplings, radio frequency couplings, and/or optical couplings. Throughout this specification and the appended claims, infinitive verb forms are often used. Examples include, without limitation: “to encode,” “to provide,” “to store,” and the like. Unless the specific context requires otherwise, such infinitive verb forms are used in an open, inclusive sense, that is as “to, at least, encode,” “to, at least, provide,” “to, at least, store,” and so on.

This specification, including the drawings and the abstract, is not intended to be an exhaustive or limiting description of all implementations and embodiments of the present systems, computer program products, and methods. A person of skill in the art will appreciate that the various descriptions and drawings provided may be modified without departing from the spirit and scope of the disclosure. In particular, the teachings herein are not intended to be limited by or to the illustrative examples of computer systems and computing environments provided.

This specification provides various implementations and embodiments in the form of block diagrams, schematics, flowcharts, and examples. A person skilled in the art will understand that any function and/or operation within such block diagrams, schematics, flowcharts, or examples can be implemented, individually and/or collectively, by a wide range of hardware, software, and/or firmware. For example, the various embodiments disclosed herein, in whole or in part, can be equivalently implemented in one or more: application-specific integrated circuit(s) (i.e., ASICs); standard integrated circuit(s); computer program(s) executed by any number of computers (e.g., program(s) running on any number of computer systems); program(s) executed by any number of controllers (e.g., microcontrollers); and/or program(s) executed by any number of processors (e.g., microprocessors, central processing units, graphical processing units), as well as in firmware, and in any combination of the foregoing.

Throughout this specification and the appended claims, a “memory” or “storage medium” is a processor-readable medium that is an electronic, magnetic, optical, electromagnetic, infrared, semiconductor, or other physical device or means that contains or stores processor data, data objects, logic, instructions, and/or programs. When data, data objects, logic, instructions, and/or programs are implemented as software and stored in a memory or storage medium, such can be stored in any suitable processor-readable medium for use by any suitable processor-related instruction execution system, apparatus, or device, such as a computer-based system, processor-containing system, or other system that can fetch the data, data objects, logic, instructions, and/or programs from the memory or storage medium and perform various acts or manipulations (i.e., processing steps) thereon and/or in response thereto. Thus, a “non-transitory processor-readable storage medium” can be any element that stores the data, data objects, logic, instructions, and/or programs for use by or in connection with the instruction execution system, apparatus, and/or device. As specific non-limiting examples, the processor-readable medium can be: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and/or any other non-transitory medium.

The claims of the disclosure are below. This disclosure is intended to support, enable, and illustrate the claims but is not intended to limit the scope of the claims to any specific implementations or embodiments. In general, the claims should be construed to include all possible implementations and embodiments along with the full scope of equivalents to which such claims are entitled.

1. A computer-implemented method of generating a motif structure comprising:
accessing, by at least one processor, a musical composition encoded in a digital file format, the digital file format stored in a non-transitory processor-readable storage medium communicatively coupled to the at least one processor;
for at least one track of the musical composition, extracting a respective motif from each of multiple bars in the at least one track;
for multiple respective sets of extracted motifs, determining a respective similarity between motifs in the set of extracted motifs;
clustering the extracted motifs into clusters based at least in part on the determined similarity between respective sets of extracted motifs; and
generating a motif structure matrix with columns indexed by bar indices and rows indexed by track indices.

2. The computer-implemented method of claim 1 wherein for at least one track of the musical composition, extracting a respective motif from each of multiple bars in the at least one track includes for each track of the musical composition, extracting a respective motif from each bar in the track.

3. The computer-implemented method of claim 2 wherein for multiple respective sets of extracted motifs, determining a respective similarity between the set of extracted motifs includes for each extracted motif in each bar of each track, determining a respective similarity between the extracted motif and each extracted motif in each other bar in each other track.

4. The computer-implemented method of claim 1, further comprising, before extracting a respective motif from each of multiple bars in the at least one track:
converting the digital file format into an alternative file format in which each track of the musical composition is designated by a respective object; and
splitting the musical composition into a set of track objects.

5. The computer-implemented method of claim 1 wherein each motif is characterized as a respective sequence of triples, with each respective triple consisting of a respective note, a respective duration, and a respective volume.

6. The computer-implemented method of claim 1 wherein determining a respective similarity between motifs in the set of extracted motifs includes identifying at least one set of motifs that are syntactically the same and identifying at least one set of motifs that are syntactically different.

7. The computer-implemented method of claim 1 wherein determining a respective similarity between motifs in the set of extracted motifs includes determining a respective similarity between motifs in the set of extracted motifs based at least in part on a quantity that is inversely proportional to a distance in distribution between distributions of features for each motif.

8. The computer-implemented method of claim 1 wherein determining a respective similarity between motifs in the set of extracted motifs includes determining a respective similarity measure between motifs in the set of extracted motifs, the similarity measure higher when motifs in the set of extracted motifs have a greater percentage of notes in common, and the similarity measure higher when motifs in the set of extracted motifs have a greater percentage of common notes in the same order.

9. The computer-implemented method of claim 1 wherein determining a respective similarity between motifs in the set of extracted motifs includes determining a respective similarity between motifs in the set of extracted motifs based at least in part on a dynamic time warping distance between motifs in the set of extracted motifs.

10. A computer-implemented method of generating a musical composition, the method comprising:
accessing, by at least one processor, a motif structure, the motif structure stored in a non-transitory processor-readable storage medium communicatively coupled to the at least one processor;
determining a number k of distinct motifs in the motif structure;
generating a chord progression comprising k chords;
assigning a respective one of the k chords to each respective one of the k distinct motifs in the motif structure;
generating a respective motif corresponding to each respective one of the k distinct motifs in the motif structure, each respective generated motif based at least in part on a corresponding one of the k chords;
assembling the generated motifs into a sequence of musical bars; and
concatenating the bars.

11. The computer-implemented method of claim 10 wherein generating a respective motif corresponding to each respective one of the k distinct motifs in the motif structure, each respective generated motif based at least in part on a corresponding one of the k chords, includes, for each generated motif, constructing a sequence of notes comprising notes available in the one of the k chords that corresponds to the generated motif.

12. The computer-implemented method of claim 11, further comprising accumulating bar durations to shift a start time of the generated motif for each bar.

13. The computer-implemented method of claim 10, further comprising:
specifying at least one mood for the musical composition, wherein generating a chord progression comprising k chords includes generating a chord progression comprising k chords, the k chords including at least one chord corresponding to the specified mood.

14. A computer program product comprising a non-transitory processor-readable storage medium storing data and/or processor-executable instructions that, when executed by at least one processor of a computer-based musical composition system, cause the computer-based musical composition system to:
access a musical composition encoded in a digital file format, the digital file format stored in a non-transitory processor-readable storage medium communicatively coupled to the at least one processor;
for at least one track of the musical composition, extract a respective motif from each of multiple bars in the at least one track;
for multiple respective sets of extracted motifs, determine a respective similarity between motifs in the set of extracted motifs;
cluster the extracted motifs into clusters based at least in part on the determined similarity between respective sets of extracted motifs; and
generate a motif structure matrix with columns indexed by bar indices and rows indexed by track indices.

15. The computer program product of claim 14 wherein the processor-executable instructions that, when executed by at least one processor, cause the computer-based musical composition system to, for at least one track of the musical composition, extract a respective motif from each of multiple bars in the at least one track, cause the computer-based musical composition system to, for each track of the musical composition, extract a respective motif from each bar in the track.

16. The computer program product of claim 14, further comprising processor-executable instructions that, when executed by at least one processor, cause the computer-based musical composition system to, before extracting a respective motif from each of multiple bars in the at least one track:
convert the digital file format into an alternative file format in which each track of the musical composition is designated by a respective object; and
split the musical composition into a set of track objects.

17. The computer program product of claim 14, wherein each motif is characterized as a respective sequence of triples, with each respective triple consisting of a respective note, a respective duration, and a respective volume.

18. The computer program product of claim 14 wherein the processor-executable instructions that, when executed by at least one processor, cause the computer-based musical composition system to determine a respective similarity between motifs in the set of extracted motifs, cause the computer-based musical composition system to identify at least one set of motifs that are syntactically the same and identify at least one set of motifs that are syntactically different.

19. The computer program product of claim 14 wherein the processor-executable instructions that, when executed by at least one processor, cause the computer-based musical composition system to determine a respective similarity between motifs in the set of extracted motifs, cause the computer-based musical composition system to determine a respective similarity between motifs in the set of extracted motifs based at least in part on a quantity that is inversely proportional to a distance in distribution between distributions of features for each motif.

20. The computer program product of claim 14 wherein the processor-executable instructions that, when executed by at least one processor, cause the computer-based musical composition system to determine a respective similarity between motifs in the set of extracted motifs, cause the computer-based musical composition system to determine a respective similarity between motifs in the set of extracted motifs based at least in part on a dynamic time warping distance between motifs in the set of extracted motifs.
